(19) United States
(12) Patent Application Publication
(10) Pub. No.: US 2021/0318121 A1
(43) Pub. Date: Oct. 14, 2021

(54) METHOD AND SYSTEM FOR GENERATING AN ELECTRONIC MAP AND APPLICATIONS THEREFOR

(71) Applicant: JAKARTO CARTOGRAPHIE 3D INC., Montreal (CA)

(72) Inventors: LOUIS-PHILIPPE LAROCHE, Montreal (CA); CEDRIC PELLETIER, Montreal (CA)

(21) Appl. No.: 17/272,464

(22) PCT Filed: Aug. 30, 2019
(86) PCT No.: PCT/CA2019/051218

§ 371 Date: Mar. 1, 2021

Related U.S. Application Data
(60) Provisional application No. 62/724,681, filed on Aug. 30, 2018.

(51) Int. Cl. G01C 21/28; G01C 11/02; G01S 17/89; G01C 21/00

(52) U.S. Cl. CPC G01C 21/28; G01C 21/3841; G01S 17/89; G01C 11/025

(57) ABSTRACT

A method, system and apparatus for processing separate data streams comprising, for example, a camera data stream, a Lidar data stream and a GPS data stream is designed to facilitate its use in a variety of exemplary applications.

### FIELD OF THE INVENTION

This disclosure relates generally to methods and system for generating an electronic map and uses therefor.

### BACKGROUND

Methods to map and survey areas of territory have evolved over time.

Typically, mapping and surveying require a physical presence of a human on the areas of territory to map and survey, and instruments such as a global positioning system (GPS), a surveying station, etc. This makes the process of mapping and surveying long and costly, because of the time required to take the measures with the instruments, because of the value and maintenance of the instruments, and because the physical presence of the human on the areas of territory is required. Moreover, the mapping and surveying can lack accuracy because of a limited number of measures taken on the areas of territory to map and survey, because of various limitations of the instruments used to map and survey, because of human error, and/or because features of the areas of territory may change over time.

More recent techniques and tools to map and survey areas of territory have been contemplated, but still present certain drawbacks. For example, tools such as Google Maps, Google Earth or the like, have limited accuracy and only present two-dimensional (2D) data of the mapped and surveyed areas of territory.

For these and other reasons, there is a need for improvements directed to data processing, including separate data streams processing.

### SUMMARY

According to various aspects of the disclosure, there is provided a method, system and apparatus for processing separate data streams comprising, for example, a camera data stream, a Lidar data stream and a GPS data stream designed to facilitate its use in a variety of exemplary applications.

These and other aspects of this disclosure will now become apparent upon review of a description of embodiments that follows in conjunction with accompanying drawings.

### BRIEF DESCRIPTION OF THE DRAWINGS

A detailed description of embodiments is provided below, by way of example only, with reference to accompanying drawings, in which:

FIG. 1 is an example of a scanning vehicle in accordance with an embodiment of the disclosure;

FIG. 2 is a simplified block diagram of a system according to the present disclosure of territory mapping and uses therefor by subscribers;

FIGS. 3A and 3B are process flows to correlate data streams produced by the scanning vehicle of FIG. 1;

FIG. 4 is a virtual scene of an urban environment derived from the correlated data streams;

FIG. 5 is a process flow identifying the steps of a process to determine a scanning route of the scanning vehicle;

FIGS. 6A to 6F are block diagrams of a different embodiment of a system for performing data curating to make the raw data more suitable for end user applications;

FIG. 7 is a process showing the different steps carried out by the systems of FIGS. 6A to 6F;

FIGS. 8A to 8B are processes for data fusion and curating;

FIG. 10 is a block diagram of showing user devices connected to an application server;

FIG. 11 is a method illustrating how a user interfaces with the data;

FIGS. 12 and 13 are data processing methods that fit external objects into a virtual scene;

FIG. 14 is a representation of a virtual scene comprising virtual objects with optional annotation blocks to provide information on the virtual objects to the user;

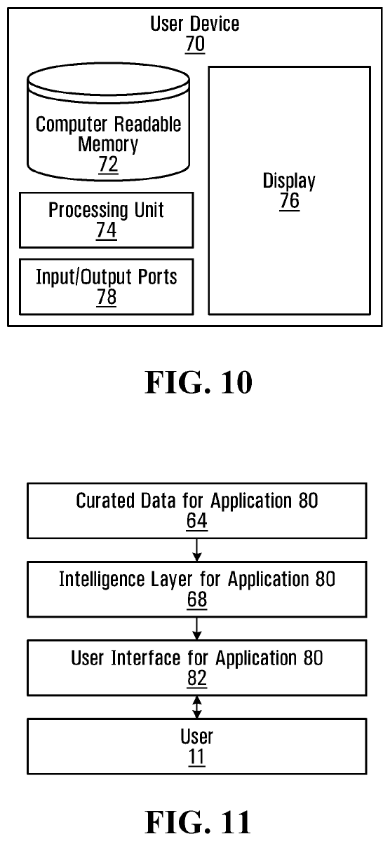

FIG. 15 is a method performed by the artificial intelligence layer for classifying the virtual objects;

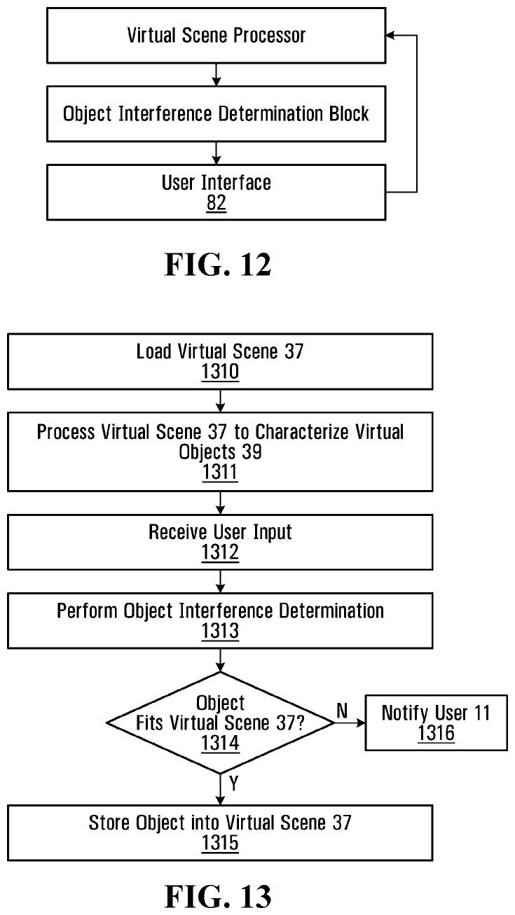

FIG. 16 illustrates optional steps that can be performed by the process of FIG. 13;

FIGS. 17 and 18 are methods to obtain or deliver a work permit in an urban environment with an embodiment of the disclosure;

FIG. 19A is an example of a linear asset, such as the power distribution lines of an AC power grid, which can be managed with the systems and methods according to the present disclosure;

FIG. 19B is a method to perform inventory of the linear assets;

FIG. 20 is a method to identify presence of objects within a safety zone of the linear assets;

FIG. 21 is a representation of a roof comprising visual discontinuities;

FIG. 22 is a block diagram of a system that interfaces the mapping information produced according to the present disclosure with satellite imaging software;

FIG. 23 is a driveway cleared by a snow removal service;

FIG. 24A is a roadway with potholes;

FIG. 24B is a method to perform pothole classification;

FIGS. 25A to 25C are block diagrams of system or system components used in an autonomous vehicle in accordance with an embodiment of the present disclosure;

FIG. 26A is a flowchart of a data curating method for an autonomous vehicle;

FIG. 26B is a representation of a virtual scene before data curating;

FIG. 26C is a representation of a virtual scene after data curating, performed by the method of FIG. 26A;

FIG. 27 is a flowchart of a process performed by an artificial intelligence layer for identifying virtual objects, during the data curating method of FIG. 26A;

FIGS. 28A and 28B are methods to compute navigational commands of an autonomous vehicle;

FIG. 29 is a method to automatically update navigation data to an autonomous vehicle;

FIGS. 30 and 31 are methods to transmit navigation data to the autonomous vehicle, according to variants;

FIG. 32A is a representation of a house and a yard depicting no-fly zones; and

FIG. 32B is a method to identify a delivery location for delivery of an item.

### DETAILED DESCRIPTION

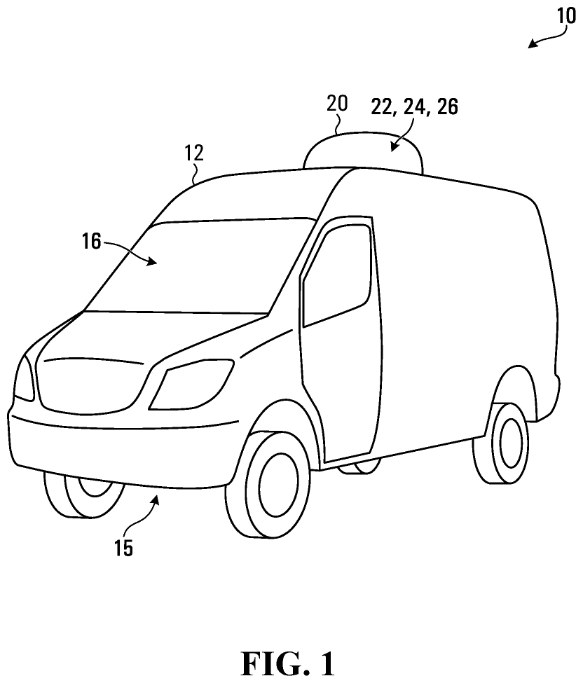

FIG. 1 shows an example of a scanning vehicle 10 for mapping and surveying a territory in accordance with an embodiment of the disclosure. In this embodiment, the scanning vehicle 10 is a van and comprises a frame 12, a powertrain 15 and a cabin 16 for an operator to operate the scanning vehicle 10, for passengers to take place inside the scanning vehicle 10, and for material to be stored. The scanning vehicle 10 has a forward direction, a backward direction, a right direction, a left direction, an upper direction and a lower direction. The scanning vehicle 10 comprises a scanning module 20, which may include various instruments for scanning an immediate environment of the scanning vehicle 10 in a continuous, automatic and/or on demand manner, in order to produce a scan 28 of the immediate environment of the scanning vehicle 10. The various instruments of the scanning module 20 may include a camera 22, a Lidar 24 and a GPS receiver 26.

In this embodiment, the camera 22 is a high definition (e.g., at least 12 megapixels per frame) camera that captures 360° of horizontal image angle, i.e., the camera 22 captures image in the forward, backward, left and right directions and therebetween.

Alternatively, the camera 22 is a first camera and the scanning vehicle 10 comprises a plurality of cameras 22, the plurality of cameras 22 altogether capturing 360° of horizontal image angle and a high degree of vertical image angle.

Alternatively, the plurality of cameras 22 are configured to facilitate photogrammetry of the immediate environment of the scanning vehicle 10, in order to refine data, notably provided by the Lidar 24, otherwise obtained. A non-limiting example of such a configuration is provided in U.S. Pat. No. 9,229,106, which is herein incorporated by reference.

In this embodiment, the Lidar 24 can have different configurations. In some cases, the Lidar 24 is a mechanical Lidar using a scanning laser beam. One measure of the scanning laser beam designates a distance between a point of a surface of the immediate environment of the scanning vehicle 10 and the Lidar 24. By mechanically operating the scanning laser beam and taking measurements at different positions of laser beam, the mechanical Lidar may provide Lidar data organized in a point cloud, where each point in the cloud is a distance measurement relative to the Lidar 24 scanning head.

Alternatively, the Lidar 24 is a solid-state Lidar.

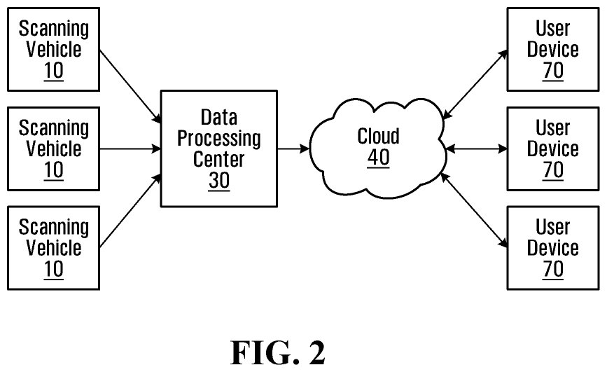

In this embodiment, the scanning module 20 collects and stores three separate data streams 27₁-27₃, i.e., image data 271, Lidar data 27₂ and GPS coordinates 27₃. As shown in FIG. 2, the data streams 27₁-27₃ of the scanning module 20 of at least one scanning vehicle 10 are provided to a data processing center 30. The data streams 27₁-27₃ may be transferred or copied to the data processing center 30 by any suitable way and in any suitable manner, e.g., continuously, automatically and/or on demand. For example, during the scan 28, the data streams 27₁-27₃ can be captured and stored on a machine-readable storage, which is then read by a suitable reader in the data center. Alternatively, the data streams 27₁27₃ can be wirelessly transmitted to the data center 30 for processing.

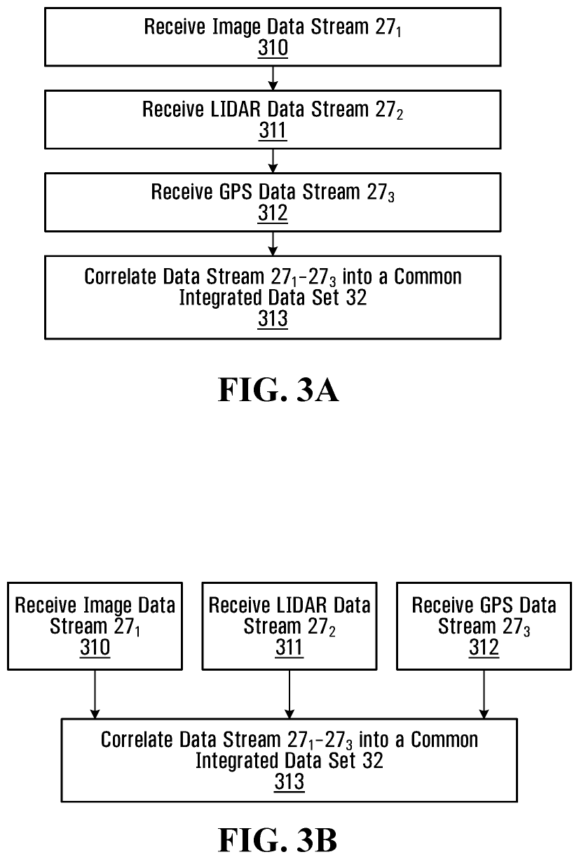

The data processing center 30 performs data fusion between the data streams 27₁-27₃. As shown in FIGS. 3A and 3B, a process flow for fusing the data streams 27₁-27₃ comprises the steps of receiving the image data stream 27₁, receiving the Lidar data stream 27₂, and receiving the GPS data stream 27₃. Afterwards, the data streams 27₁-27₃ are correlated into a common integrated data set 32 where pixels or pixel blocks 34 in the image data stream 27₁ are associated with a depth or distance dimension 35 derived from the Lidar data stream 27₂; in addition, the GPS coordinates 27₃ allow positioning geographically each pixel 34 or block of pixels. Therefore, the integrated data set 32 may be considered as a data set that is a combination of the image data component 34, the Lidar data component 35, and a GPS data component 36. The integrated data set 32 creates a virtual scene 37 of the scanned environment that is dimensionally accurate, in other words, dimensions of virtual objects 39 in the virtual scene 37 are an accurate representation of real objects 5 and distances between virtual objects 39 and relationships between virtual objects 39 in the virtual scene 37 are accurate representations of distances and relationships between the real objects 5.

In some embodiments, while the process flow shows that receiving image data stream 27₁ occurs prior to receiving Lidar data stream 27₂, which occurs prior to receiving GPS data stream 27₃, these steps may be accomplished in any order and, in some embodiments, simultaneously.

In some embodiments, the scanning vehicle 10 may acquire the data streams 27₁-27₃ by following a pre-determined route 50, and the pre-determined route 50 may be computed to maximize the size of the area being scanned by the scanning vehicle 10 during a pre-determined period of time, e.g., during one day.

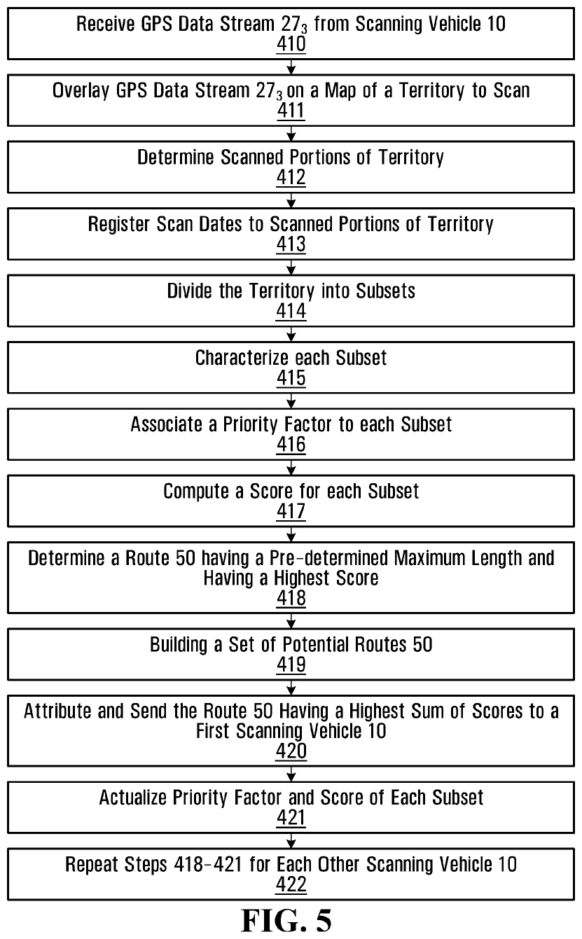

The determination of the route 50 may be done in any suitable way. For example, in some embodiments, as shown in some detail in FIG. 5, the GPS data stream 27₃ is overlaid on a map of an area to be covered. Based on an overlay of the GPS data stream 27₃ on the map, the system determines a part of the territory that has been scanned and registers a scan date of the scan. In parallel, the territory is divided into subsets and a priority factor is assigned to each subset of the area, depending on time elapsed since a latest scan of that particular subset. For example, an area of a municipality may be split into subsets wherein each subset is a stretch of road between consecutive intersections, and the priority factor may range from 0 to 10: 0 representing a stretch of road which is already scanned by another scanning vehicle 10 reporting to the same data processing center 30 during the same day; 10 representing a stretch of road which was never scanned; and the priority factors from 1 to 9 increasing as the time elapsed since a latest scan 28 increases. A score may be attributed to each stretch of road by multiplying a length of the stretch by its priority factor. A unique index number is randomly assigned to each scanning vehicle 10. A maximum distance (e.g., 100 km) is determined, and each scanning vehicle 10 cannot scan more than the maximum distance during each pre-determined period of time (e.g., one day). The route 50 for the scanning vehicle 10 having the lowest index number is determined first, and among every possible route 50, the route 50 cumulating a highest sum of scores is retained. Subsequently, the route 50 for the scanning vehicle 10 having the second to lowest index number is determined in the same way, and so on.

In some cases wherein there is a need to substantially prioritize never-scanned stretches of road over any other stretches of road, a relatively high priority number can be assigned to never-scanned stretches of road. For example, the priority factor may be about 50, 100, 200, etc., for never-scanned stretches of road, while it may range from 0 to 9 for other stretches of road, such that the never-scanned stretches of road will be highly prioritized during the determination of the route 50.

In some cases, a certain threshold may be determined to consider stretches of road having a time elapsed since a latest scan exceeding the threshold to be never-scanned stretches of road.

Note that this example of a method to build the route 50 is exemplary and non-limitative, and that any other method or system may be retained to determine the route 50 of the scanning vehicle 10.

In some embodiment, after the data fusion is completed at the data processing center 30, the data set 27 is uploaded to a cloud 40 such that it is made available to users 11. With additional reference to FIG. 2, users 11 connect to the cloud 40 using user devices 70 in order to have access to the data set 30. In some variants, user inputs 46 into the cloud 40 can change that data set 30, by updating it or upgrading it as discussed below.

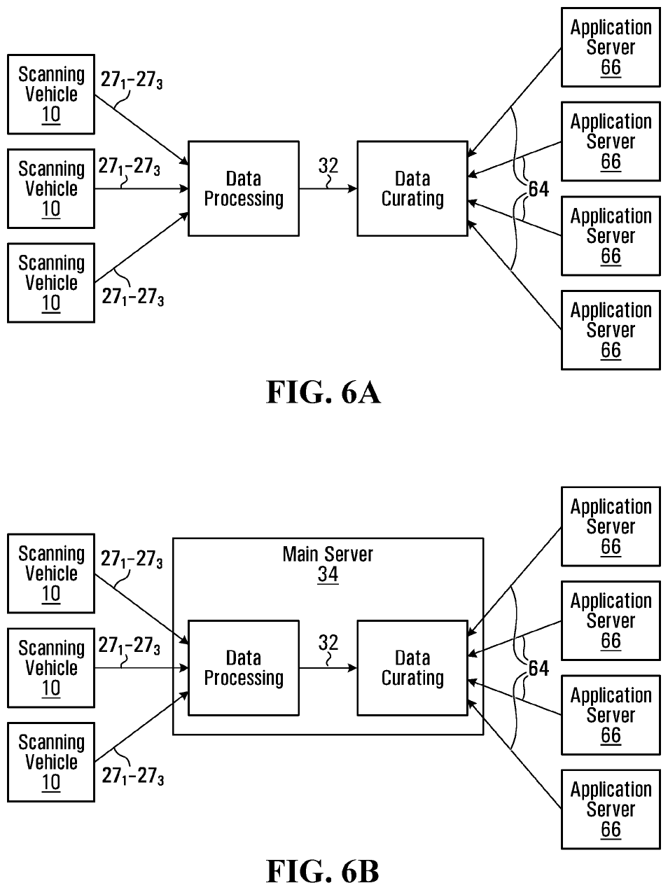

With additional reference to FIGS. 6A-6F, in some embodiments, data streams 27₁-27₃ are processed by a computer infrastructure. The image data stream 27₁, the Lidar data stream 27₂ and the GPS data stream 27₃ are fused as described above using software at a main server 34. The main server 34 outputs the common integrated data set 32. In this case, the common integrated data set 32 is raw fused data; therefore, the raw fused data 32 is then subjected to curating, which is intended to refine it, and make it more usable for specific applications. Accordingly, curating is an application specific process.

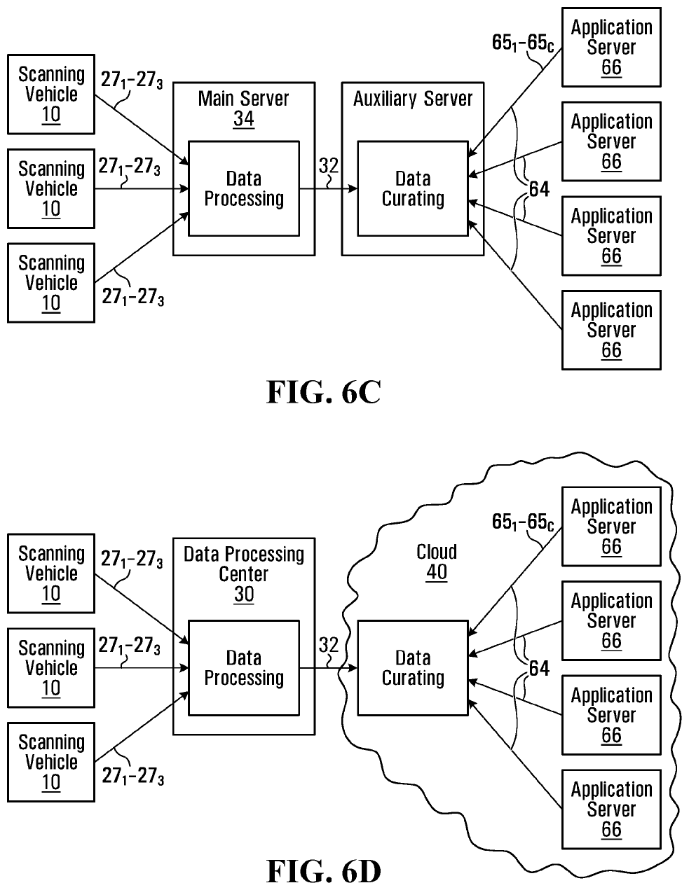

With additional reference to FIG. 7, curating the raw fused data 32 into curated data 64 may include, for example: filtering the raw fused data 32; regrouping the raw fused data 32 into subsets; characterizing areas of territory; deriving statistical data from the raw fused data 32; formatting the raw fused data 32 into an application-compatible format; etc. Filtering the raw fused data 32 may include removing data considered harmful and/or useless for the intended application. Data considered harmful may comprise incorrect and/or inconsistent data that can be caused, for example, by: false distance measurements of the Lidar 24 taken during snowy, rainy and/or windy conditions; artefacts created during capture of the data streams 27₁-27₃; artefacts created during the data fusion; etc. Regrouping the raw fused data 32 into subsets allows the system to match the raw fused data 32 of same areas of territory, to compare the matched raw data from different scanning vehicles 10 (to the extent there is an overlap), and to discard the duplicates. For example, the subsets may be a stretch of road between consecutive intersections and for each stretch of road, only one scan per day may be retained, i.e., supplementary scans may be removed from the raw fused data 32. Characterizing areas of territory and deriving statistical data from the raw fused data may, for example, indicate an average time elapsed since a latest scan for each area of territory, indicate geographical and topographical details, etc. Formatting the raw fused data 32 into an application-compatible format may reorganize the data provided in the raw fused data and adding or removing codes from raw fused data files to render the files compatible with softwares and applications available on the market, including CAD softwares and applications (e.g., Catia™, Solidworks™, Inventor™, CityCAD™, EDrawings™, etc.), mapping softwares and applications (e.g., Google Maps™, Google Earth™, etc.), urbanism softwares (e.g., ESRI CityEngine™, Modelur™, City Form Lab™, Urban Canvas™, SketchUp™, etc.), virtual reality and enhanced reality softwares, applications and videogames, management softwares and applications (e.g., Microsoft Excel™, Mavenlink™, Monday™, Smartsheet™, etc.).

Curating may be processed by a software 62 executed by the server in the data processing center 30. In some cases, the curating is processed by a processing unit of the main server; in some cases, the curating is processed by a processing unit of an auxiliary server. In some cases, the data fusion and the curating are processed in a same processing unit; in some cases, the data fusion and the curating are processed at different processing units.

With additional reference to FIG. 9, in some embodiments, the curated data 64 is partially or entirely offloaded to application servers 66 and rendered available to users 11 via the application servers 66. In other words, users 11 may connect to a given application server 66 to have access to the curated data 64, using a user device 70. The user device 70 may be a workstation and comprises computer readable memory 72, a processing unit 74, a display 76 and input/output ports 78. Alternatively, the user device 70 may be a laptop, a smartphone, a tablet, a phablet, an on-board computer, or any suitable device.

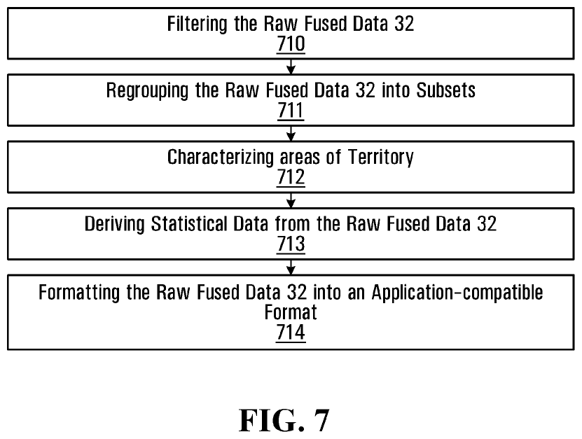

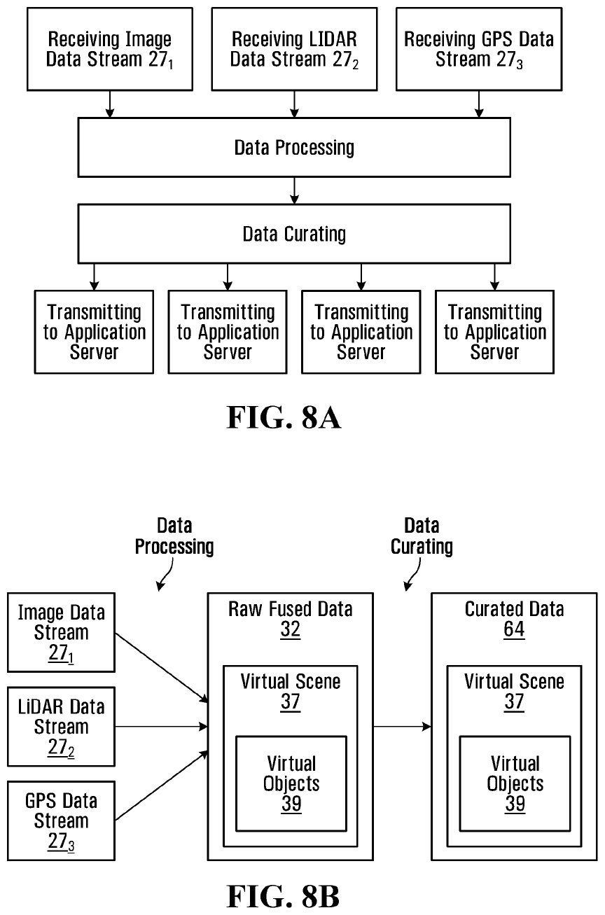

With additional reference to FIGS. 10 and 11, the user 11 accesses the curated data 64 using the workstation 70, and through an intelligence layer 68, which may be part of the software 62. The intelligence layer 68 performs data analysis which is specific to the application 80. The user 11 interacts with the curated data 64 through a user interface 82 of the application 80 that has tools to assist with viewing and manipulation of the curated data 64. Examples of the intelligence layer 68 will be provided later.

Alternatively, the intelligence layer 68 may be part of the application 80 rather than part of the software 62. In some embodiments where the software 62 and the application 80 are unitary, the intelligence layer 68 is part of both the software 62 and the application 80.

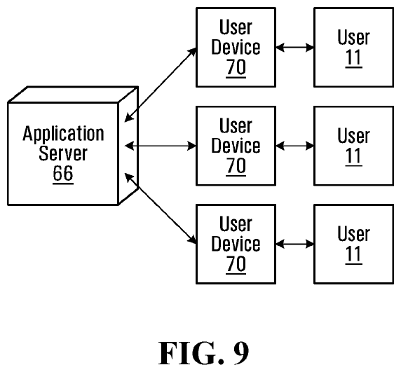

For example, it may be necessary when doing urban management to determine if an object 85, such as a large container, can be safely placed at a certain desired location. With additional reference to FIG. 12, in this example, the intelligence layer 68 may achieve this by determining if a virtual representation 89 of the external object 85 can properly fit in a corresponding virtual location of the virtual scene 37. Based on knowledge of the external object 85 characteristics (e.g., size, shape), the intelligence layer 68 may build the virtual representation 89 of the external object 85. The intelligence layer 68 has a virtual scene processor, an object interference determination block and the user interface 82 through which the user 11 manipulates the virtual representation 89 of the object 85 to figure out if the object 85 can fit in the corresponding virtual location in the virtual scene 37, and thus if the external object 85 can fit in the desired location.

In this example, with additional reference to FIG. 13, a method of the intelligence layer 68 is provided to determine if the object 85 can be safely placed at the desired location. At step 1310, the virtual scene 37 is loaded for processing. That operation may happen dynamically as the user 11 manipulates the curated data 64. For example, as the user 11 pans, zooms in and out of the curated data 64 the virtual objects 39 making up the virtual scene 37 viewed by the user 11 through the user interface 82 are automatically loaded and ready for processing. At step 1311, the intelligence layer 68 may perform object characterization of the virtual scene 37. During the object characterization, the intelligence layer 68 recognizes and identifies virtual objects 39 in the virtual scene 37 and classifies the virtual objects 39 in the virtual scene 37 as discrete entities, depending on a particular application of the intelligence layer 68. For instance, in an urban environment, the object characterization of the intelligence layer 68 comprises identifying in the virtual scene 37 objects 39 defining the urban environment over other environments and with which the user 11 would normally interact. Examples of objects 39 for urban management may include:
dwellings such as houses, residential buildings, industrial buildings, farms, etc.
sub-components of dwellings, such as doors, garage doors, balconies, windows, fences, pools, driveways, garbage disposal equipment, etc.;
street signs, road signs;
fire hydrants;
boundaries of streets or roadways;
traffic lights;
pedestrian crossings;
sewer hole covers;
light posts, telephone posts, electrical posts;
etc.

The object characterization at step 1311 includes processing the image information contained with the curated data 64 to classify the objects appearing in the scene. This can be performed by using an artificial intelligence (AI) layer 63 that has been trained in order to recognize the objects 39 in the scene 37.

The AI layer 63 of the software 62 of the data processing center 30 classifies objects 39 by looking into the image for certain object characteristics, which are processed by the AI algorithms to determine if there is a match with an object in the database of objects. For example, the AI layer 63 identifies characteristics such as shape, dimension, color, pattern, location, etc and assigns to the characteristics so observed in the scene, predetermined weights to determine if collectively those characteristics allow establishing a match with an object in the database. In addition to the image data component, the classification process may also use as a factor, the Lidar data component that provides a three dimensional element to the two dimensional image data.

By combining the two dimensional data derived from the image data and the depth information derived from the Lidar data, it is possible for AI layer 63 to provide a detailed dimensional characterization of the virtual objects 39 in the scene. The dimensional characterization of the virtual objects 39 provides a three-dimensional definition of the virtual objects 39, which is enhanced to what the image data individually provides. The AI layer 63 may use the Lidar data component 65₂, associated with each pixel or block of pixels of the image data component 65₁ to derive distance information with relation to a certain reference point, the reference point being typically the scanning head of the Lidar 22 of the scanning vehicle 10.

The output of step 1311 is to provide a list of virtual objects 39 that appear in the scene, their dimensions and their relative position in the scene 37. In some embodiments, it may be possible to obtain full a three-dimensional representation of each virtual object 39 of the virtual scene 37. In some cases, this may be impossible since the scanning operation may not be able to image the objects on all sides. For example, in the case of a house, a scanning vehicle 10 driving on a street may only image a front, and in some occasions, sides of the house, but not a back of the house. In those circumstances, the virtual object 39 is only partially characterized dimensionally.

In instances where the AI layer 63 can see only a side of a certain object, for example the side facing the street traversed by the scanning vehicle, logic can be provided to estimate the dimensions of non-scanned part of the object 39 based on some pre-determined assumptions. For example, in the case of a certain building that has been scanned only from the front, the software may make assumptions on the depth of the building, based on statistical dimensions of other buildings in the vicinity. Alternatively, as discussed later, the software may use satellite imaging information to get a bird's-eye view of the scene, which provides an additional view of the object, and provides a more precise reconstruction.

The classification operation allows compiling an inventory of different objects 39 throughout a given territory. For example, the software 62 of the data processing center 30 identifies all the fire hydrants and creates a database showing their location. The same can be done for light posts, sewer-hole covers, street signs etc. In this fashion, the municipality has an inventory of installed equipment, which is updated on a regular basis; hence it is accurate all the time. The inventory is essentially a list of the different objects and their properties such as the geographic location, model or submodel to the extent it can be recognized in the image data, operational state a nonoperational state, again to the extent that can be seen in image data, or any other property. The inventory evolves dynamically every time the scan of the territory is updated. In other words, new objects that belong to a category of objects intended to be recognized are added to the inventory, which would happen when a new neighborhood is being developed with new constructions. Accordingly, the municipality does not need to spend time to create an inventory of its equipment and installations since that happens automatically.

As indicated earlier, property of an object that the software is trained to detect is the operational state of the object, or a condition of the object that may require maintenance. An example is a lamp in a light post that may have burned out. Assuming a scan is performed at the time of day when lampposts are all lit, such as during the evening, the software can be configured to identify among the lampposts on either side of the street those that are functional and those that are nonfunctional. For nonfunctional lampposts an entry is made in inventory to denote their nonfunctional state. Optionally, an alert can be sent to a management crew identifying the nonfunctional lampposts by their location so that suitable repairs can be made.

In another example, the software 62 may detect paint imperfections on fire hydrants and add a layer of description of paint condition in the database showing the location of the fire hydrants. Fire hydrants are of a relatively uniform red or orange color and it is possible through image analysis to assess the paint condition. If the color of the fire hydrant differs by a predetermined degree from the standard color, the software notes the condition in the inventory. Optionally, an alert can be sent to a management crew to perform maintenance on the fire hydrant.

In another variant, the software 62 may measure a structural characteristic of the vertical structure such as a lamppost. A structural characteristic may be the vertical orientation; lamppost or other vertical structure which is tilted too much, may be a sign of a failing base, hence the risk that the vertical structure may collapse. The logic for assessing the degree of inclination of an elongated object based on the image data is discussed later in the application. In the case of a lamppost, if the latter is inclined or out of shape, it may be the result of an impact that has weakened its structure and it might need to be replaced or repaired. Accordingly, if the software 62 identifies such a vertical structure it makes a note in inventory and optionally, as discussed earlier, may dispatch automatically a repair crew to fix the problem.

Once the classification operation is completed, the user 11 can interact at step 1313 with the virtual scene 37 and find, for example, a location for the external object 85 in the virtual scene 37. In the specific example where the user 11 wants to find a location for a container in the virtual scene 37, the user 11 can select the container 85 among a selection of external objects 85, and drag and drop the container 85 onto a desired location at the scene.

At step 1314, the software 62 of the data processing center 30 verifies if the external object 85 dimensionally fits into the desired location, by computing interference between the virtual representation 89 of the external object 85 and the virtual scene 37. During steps 1315, 1316, 1317, the software 62 accepts the external object 85 if the external object 85 dimensionally fits there, i.e., if no interference is found between the virtual representation 89 of the external object 85 and the objects in the virtual scene 37, and does not accept the external object 85 if an interference is found. In the specific example where the user 11 wants to find a location for the external object 85 which is a container for construction debris, the software 62 may fit dimensionally the container 85 between virtual objects 39 in the virtual scene 37 to determine if the desired location, at which the user 11 wants to drop the container 85, is large enough to receive the container 85. If the desired location is large enough to receive the container 85, the software 62 may allow the “drop” operation and may integrate the container 85 into the virtual scene 37, locking the container 85 relative to the other virtual objects 39 of the virtual scene 37.

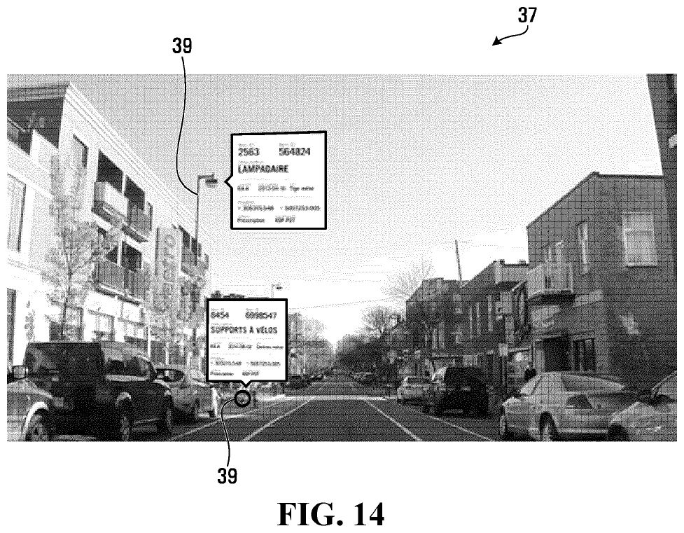

In some embodiments, as shown by the process flow in FIG. 16, step 1334 may involve more sophisticated fit rules, in addition to merely performing a dimensional fit. For example, some areas of the virtual scene 37 may be restricted and/or some external objects 85 may have restrictions to be complied with. For example, the software 62 may prevent the user 11 to drop: the external object 85 on a street, as this would block circulation on said street; the container 85 in front of a fire hydrant, as this would prevent access to said fire hydrant; the container 85 over a sewer, as this would block said sewer; etc.

In some embodiments, the dimensional fit rules and the more evolved fit rules form a list of rules that are checked once the desired location is set. For example, when the user 11 drops the external object 85 on a street of the virtual scene 37, the software 62 runs through the list of rules to identify relevant ones to consider and comply with if necessary. The relevance of a particular rule depends on the virtual objects 39 identified at the scene 37. For instance rules may be associated to different objects. This software identifies the immediate environment in which the container is placed to determine which objects are in that immediate environment and derives a new list of rules to be complied with. For example, if there is a fire hydrant in the virtual scene 37, the software 62 will determine that the rules associated with the fire hydrant as being relevant for the process. However, if the intelligence layer 68 did not detect any fire hydrant at steps 1310, 1311, 1312 and 1313, the software 62 will disregard the rules associated with the fire hydrant as being irrelevant for the operation.

An example of a rule associated with the fire hydrant is one where an object cannot be too close to the fire hydrant to block it. That rule may specify a minimum distance at which the container 85 can be placed relative to the fire hydrant. In determining if the fit of the container 85 is possible at the location specified by the user, the software determines if the minimum distance is complied with. If it is not, an error message is generated or more generally the drop operation is not allowed to proceed.

As another example of a rule associated with a street is one where if the user 11 wants to drop the external object 85 on a street and there is a fit rule stating that an object cannot occupy more than a pre-determined portion of the street, the software 62 will determine that rule to be relevant because the street, which is an object identified in the scene is in close proximity to the container 85. Based on the dimensions of the container 85 and the requirements of the rule, the software will determine to which extent the street will be blocked widthwise and will allow the drop operation at the condition the rule allows it.

Another example of a rule is one associated with a driveway entrance. Similar to the fire hydrant, the driveway entrance is associated with its own set of rules, one being that it cannot be blocked by an object. As discussed above, the software will compare the distance between the container 85 and the driveway entrance to determine if the location of the container 85 violates the specific rule.

In some embodiments, the software 62 may notify the user 11 of non-compliance with a rule and identify a reason for non-compliance. For example, if the user 11 tries to put the external object 85 such as a container too close to a fire hydrant, the software 62 indicates to the user 11 that the fire hydrant rule is violated and the external object 85 should be moved a certain distance further away from the fire hydrant to comply with the rule.

In some embodiments, if a rule (dimensional fit, law or regulation, etc.) is infringed, the software 62 may display an alert, warning the user 11 that the rule is infringed, but still allow the user 11 to force the “drop” operation.

In some embodiments, the software 62 may allow the user 11 to customize the list of rules of the software 62. For example, in an “options” panel, the user 11 may activate, deactivate, or modify thresholds of pre-determined rules of the software 62.

Optionally, the software 62 may provide an automatic fit functionality, which automatically (i.e., without the “drag and drop” operation) finds a proper location for the external object 85, in the event a fit cannot be rapidly achieved by manual means. For example, in some cases, the software 62 may suggest an allowable location for the external object 85 into the virtual scene 37 after the desired location has been rejected by the software because of a rule infraction. For instance, if the user tries to put the external object 85 too close to a fire hydrant, the software 62 may suggest to slightly reposition the external object 85 such that it is at an acceptable distance from the fire hydrant.

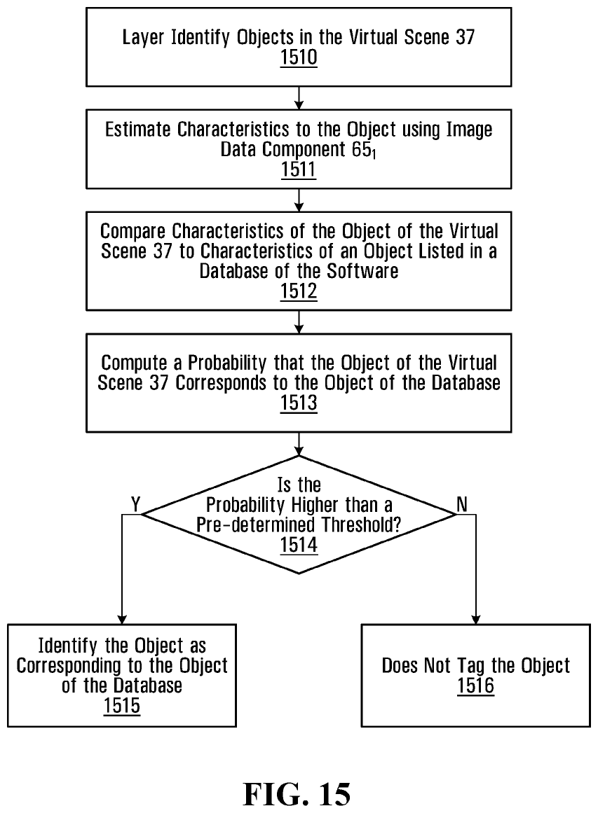

In some embodiments, the software 62 may provide means to the user 11 to obtain a work permit 95 for construction on the territory. For example, with additional reference to FIG. 17, at step 1710 the user 11 may select the desired location of the external objects 85 into the virtual scene 37. This may be achieved in various ways: in some cases, access to the software 62 is made through a web site of a municipality with tools that allow the user 11 to find the virtual scene 37 at a location of a construction site. The user 11 may put the external object 85 in a place that meets regulations and have the software 62 automatically issue a permit 95. If payment is required, the software 62 can comprise a payment module to accept payment using any suitable payment mechanism. At step 1711, a request for work permit may be issued directly though the software 62 or by any other means. At step 1712, the work permit is issued and transmitted to the user 11. For example, an e-mail may be sent to the user 11 identifying a location at which the external object 85 is to be put, and a duration for which the permit is valid. At step 1713, parameters of the work permit are entered into the software 62 in an automatic or manual manner. The software 62 can also have a reminder module to issue periodic reminders to the user 11 about a permit expiration date, offering, in some cases, an option to review or extend the permit through payment of an additional sum.

In some embodiments, the software 62 is configured to allow the user 11 (representative of a municipality) to deliver the work permit 95 for construction on the territory to a client, such as a resident of that municipality. With additional reference to FIG. 18, at step 1810, the desired location of the external objects 85 into the virtual scene 37 is set by the user 11. At step 1811, the work permit 95 is issued and delivered to the client. For example, an e-mail may be sent to the client identifying the location at which the external object 85 is to be put and a duration for which the permit is valid. A rule is created by the software, which is associated with the container 85 to indicate the location of the container and also indicate that the existence of the container in the scene is limited to a certain duration. Subsequent scans will test the rule; if the container is still seen in the scenes derived from scans performed after the due date of removal of the container 85, the rule is deemed to be violated and an alert is raised. At that point, an e-mail or other form of communication is sent to the user 11 to notify the user 11 that the external object 85 is now illegally placed and must be removed. The user can be offered an option to extend the duration of the permit or get a new one, if desired.

The process of identifying and classifying virtual objects 39 in the virtual scene 37 is performed through AI, such as machine learning. For instance, the software 62 can be configured as a neural net that can be trained with a data set in order to recognize with a high degree of confidence the various virtual objects 39 that need to be identified in the virtual scene 37.

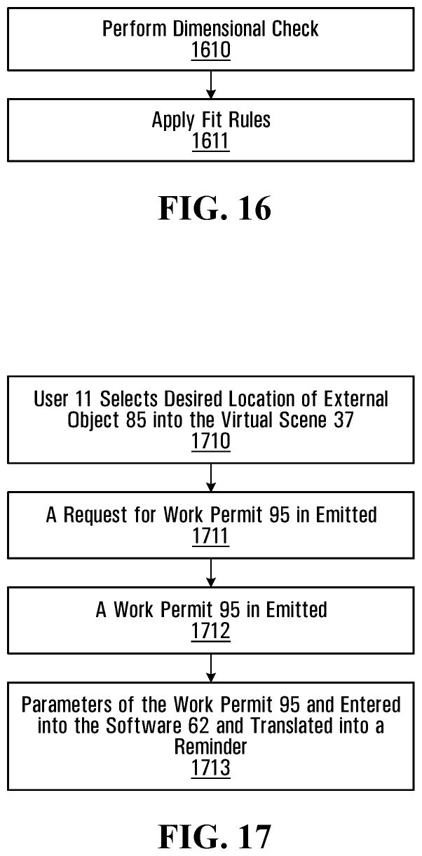

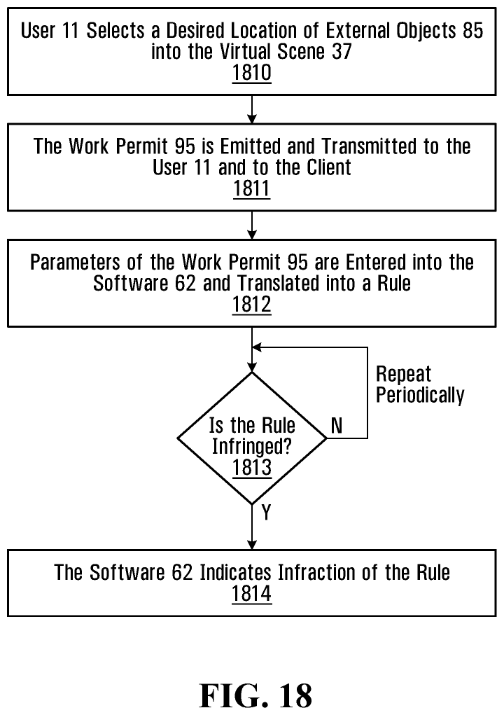

In another possible embodiment, with additional reference to FIGS. 19A and 19B, the software 62 can be used to manage an inventory of linear assets 96, such as power transmission lines or telecommunication lines. As per the principles discussed earlier, at step 1910, the software 62 is trained to recognize and categorize virtual objects 39 that are components of the linear assets 96 in the virtual scene 37. For example, in the case of an electric distribution utility, the software 62 can recognize linear assets 96 comprising electric line poles, spans of electrical power transmission lines between poles and electric power distribution equipment, such as power transformers.

At step 1911, once recognition and classification of the virtual objects 39 composing the linear assets 95 is made, determination of properties of linear assets 96 is done by the software 62. For example, the software 62 can determine the degree of inclination of a pole. In a possible implementation, the software first identifies an approximate longitudinal axis of the pole and determines an angle of the longitudinal axis relative to the horizon using the image data component 65₁ of the curated data 64. When the angle is outside of a pre-determined range that is considered to be normal, a notification may be made to the user 11 to suggest that some poles may be too inclined and may pose a risk of collapsing and damaging a property.

Also, when the angle is outside of a pre-determined range that is considered to be normal, a possible variant is for the software 62 to automatically issue a work order to a repair crew, or dispatch an inspector to assess a situation and determine if corrective action is required.

In yet another example, the software 62 can determine the condition of power line spans running between poles. For example, power lines may sag to some degree, which indicates a degree of tension in the line. Excessive sag may indicate excessive tension, which needs attention. Ice accretions on the line add weight that stretch the line and can cause excessive tension. In some cases, the software may determine the degree of tension in the power line by measuring a degree of sag between two poles in the virtual scene 37. Sag is assessed by image analysis, for example by finding an arcuate geometric segment between poles and then finds a nadir of the segment, which would coincide with the center of the segment. A radius fit determination may then be made which provides an approximation of the degree of sag—the smaller the radius, the larger the sag.

Alternatively, sag may be determined on the basis of the vertical distance between the lowest point of the line (nadir) and the two points at which the line connects with the poles.

If excessive sag is identified, the software 62 can include logic to generate a notification through the user interface 82 in order to notify the user 11 of the excessive sag condition. As indicated with previous embodiments, the software 62 can also issue automatically a work order to a repair crew, identifying the location of the problem and the nature of the problem.

At step 1912, once determination of the properties of the linear assets 96 is done, an inventory of the virtual objects 39 composing the linear assets 95 can be built. The inventory maps each virtual object 39 of the linear assets 95 to specific properties, such as a geographic location, defect condition or operational state. The inventory, which is in the form of a database, is searchable to identify specific items of interest to the user 11, such as for example poles that are inclined beyond a certain limit. In this fashion, maintenance of the power distribution grid is facilitated because there is no need (or limited need) to perform inspection work by human inspectors. If the scans of the territory are performed at reasonable intervals, the inventory and the condition of the objects are maintained up to date.

Yet another variant is to configure the software 62 to recognize situations in which vegetation is too close to objects 39 composing the linear assets 95. For example, the software 62 may recognize situations in which vegetation is too close to power lines. Currently, vegetation control and surveillance is performed by visual inspection: employees of a utility company must visually inspect power lines or rely on the public to notify the utility company about trees or vegetation that grows too close to a power line. Such a system is inefficient because human inspection is costly and in many instances, overgrown vegetation is not detected and creates a safety hazard.

With additional reference to FIG. 19C, the software 62 recognizes the potentially dangerous situations by identifying a safety volume around the linear asset 95, such as the power line or other component of the linear asset. At step 1920, the software 62 identifies the safety volume surrounding the power line. For example, that safety volume may be a virtual cylinder centered on the power line 95 and having predetermined dimensions. At step 1921, the software 62 identifies objects 39 in the scene which penetrate the safety zone, for example within the virtual cylinder around the power line 95.

As a possible refinement, step 1921 may comprise a classification of the objects 39 to figure out, for example, if it is vegetation or something else, and/or if the objects 39 are potentially harmful. For example, vegetation may not be an immediate problem since it grows slowly—accordingly the work plan to cut it down may be according to normal timelines. Other objects 39, however, may indicate more immediate concerns, e.g., risks of electrocution. Examples of virtual objects 39 other than vegetation include elevated construction vehicles such as cranes and other similar man-made objects. At step 1922, the software 62 notifies the user 11 regarding the presence of objects 39 within the safety volume surrounding the power line 95. As a possible refinement, step 2012 may also include dispatching a request to an inspection crew to visit a location of the linear asset 95 identified by the software 62 and secure the premises such as to avoid accidents.

In examples above, the management of linear assets 95 was done in connection with an AC power distribution grid. Nonetheless, a similar approach can be taken in the case of telephone or cable utility companies that have cables and other equipment installed throughout the territory that is scanned. For example, wiring cabinets where telephone cabling from homes arrives for connection to a transmission trunk may be managed using the software 92. The software 62 can be designed to detect and classify those, such as to create an inventory of that equipment.

As another example, pipelines for transporting water or petroleum products such as gas, fuel, oil, and the like, may also be managed by the software 62, at the condition a roadway runs alongside the linear asset to allow the scanning vehicle to perform the scan. In the case of a pipeline, successive scans can be compared to derive a measure of the evolution of the pipeline and identify potential defects or conditions that require intervention.

Another possible application of the software 62 is to allow a municipality to keep track of changes made to one's property and identify the legality of those changes and/or whether they attract a tax or fee.

The software 62 performs classification of objects in the scanned data and those objects classified can be compared, among scans made at different periods of time to determine material changes to a property, either to the landscaping or to a house erected on a lot.

Municipalities derive tax revenue based on improvements made to one's property. The amount of tax charged is dependent on the extent of the changes made, including addition of rooms or simply expansion of the structure of the dwelling. In many instances, a municipality will not charge any specific tax amount but will increase the property assessment; when the assessment increases the overall tax bill will increase.

For that specific application, the software 62, in particular the AI layer 63 is trained to identify (classify) dwellings in the territory in which the scan is made. The classification process is configured to distinguish the dwelling from the immediate surroundings. For example, the software will look into the image for features that are normally associated with a house to determine the extent of the dwelling, such as a stairway, a garage door or similar structures, which are normally part of a dwelling. Once the processing identifies the boundaries of the dwelling (including associated structures) it creates a virtual object, which is stored in a database.

The same processing is performed in a subsequent scan. For a given dwelling, therefore, the database stores virtual objects of the same dwelling corresponding to different scan dates. It is therefore possible to compare the various virtual objects, once a new scan is completed to see if any major changes have occurred to the virtual object boundaries, which may suggest an important modification to the dwelling. If such changes are detected, an alert can be issued such that an inspector can be dispatched to the property in order to make a determination whether indeed a change has been made and in the affirmative the impact on the property assessment.

Note that during certain time periods of the year, such as the summer time, vegetation may be a factor in properly determining the boundaries of a dwelling. Large trees or shrubs may obscure the dwelling making the determination of the boundaries difficult and sometimes impossible. To make vegetation less of a factor, the virtual objects of the dwelling that are stored in the database may be derived from scans that occur during a period of the year when vegetation is not as abundant as it is during the summertime. For example, in northern climates the virtual objects are created from scans during the spring or the fall, immediately before the winter.

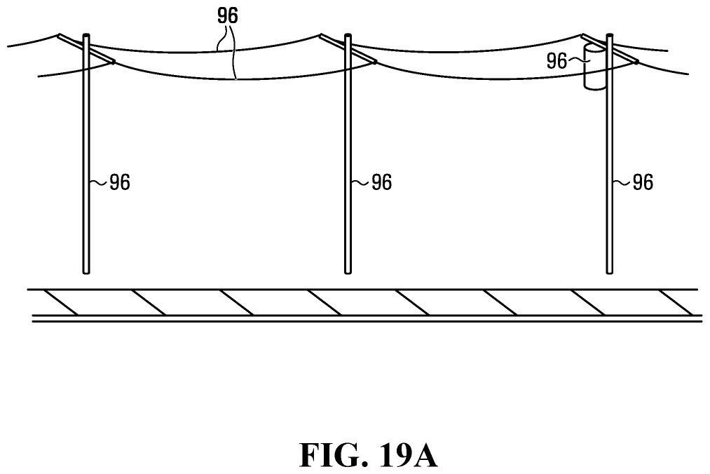

The flowchart at FIG. 20 describes the process—see below.

In another example of implementation, the software can be configured to assess the legality of changes made to a property and to flag those to authorities. A specific example in that context is illegal vegetation removal, in particular on lakefronts, which can have negative environmental impacts.

In previous examples, the scanning vehicle is a road vehicle however, the scanning vehicle can also be a boat configured to perform a scan of the shore of a lake. The software 62 is configured, in this application, to recognize in the image vegetation, such as larger trees and account for them such that their presence can be verified in subsequent scans. The process for performing the object classification includes looking for features in the image, which are representative of vegetation. In a specific example, the software is configured to identify trees larger than a certain height in the image, which are of most interest. Smaller trees or shrubs are in practice difficult to identify and practically it may not be necessary to track them.

The AI layer 63 may classify objects as trees based on color and shape. Objects that display a green color, an irregular outline and having a height above a threshold are classified as trees. As long as these three parameters are present, the AI layer considers that a tree exists and creates a vertical object, defined by its properties, namely color outline and approximate size. That object is stored in a database.

Subsequent scans are processed in a similar fashion. Virtual objects corresponding to trees are derived from the image and stored in the database. A comparison is then made between the virtual objects derived from a previous scan and those in a current scan, for a given geographical area. If no trees have been illegally cut, there should in principle be a match. In other words, the objects in one scan will exist in the other scan too.

The match will not be perfect since trees grow and some of the parameters of the virtual tree object will change. The software 62 is configured to account for a normal growth factor to avoid triggering a false alarm. In addition to growth, trees also change, in particular limbs can break and fall that will be detected in the scan. The software can be configured to account for such limb loss as well. For instance, the software can detect a match as long as there is a minimal degree of equivalency between the two vertical objects. For example, if the height dimension of one virtual object is within 80% of the height dimension of the other virtual object, the software will still consider that a match exists.

If no match is found, an alert is triggered to the user, presumably an employee of the municipality, allowing sending an inspector to inquire. Alternatively, the user may be presented via the user interface with an image of the vertical object of a previous scan and image of the vertical object with the current scan to allow visually determining on the display if a manual inspection is necessary.

The software is configured with specific features in order to manage situations where trees are cut, but in a lawful manner and thus avoids triggering unnecessary alarms. For instance, the user interface include controls allowing the user to designate a virtual tree object as being authorized for removal in which case it will be deleted from the database from all previous scans. Practically, a tree may die and the owner of the property on which the tree exists notifies the municipality that they want an authorization to remove the dead tree. If necessary, an inspector visually confirms that the tree is dead and the authorization is issued. Along with the issuance of the authorization the inspector logs into the computer system, identifies based on the address the property and selects among the virtual tree objects shown, the one tree that has died. The software 62 then deletes the tree vertical object from the database such that during subsequent scans the tree will not accidentally show as being illegally removed.

The software 62 can also be used for marketing and potential client identification regarding certain products and services. Examples include:

1) Roofing Condition and Pricing Determination

In some embodiments, the software 62 may identify roofs 112 that need repair and determine approximate cost for repairing and/or re-surfacing based on an estimation of the surface area of the roof.

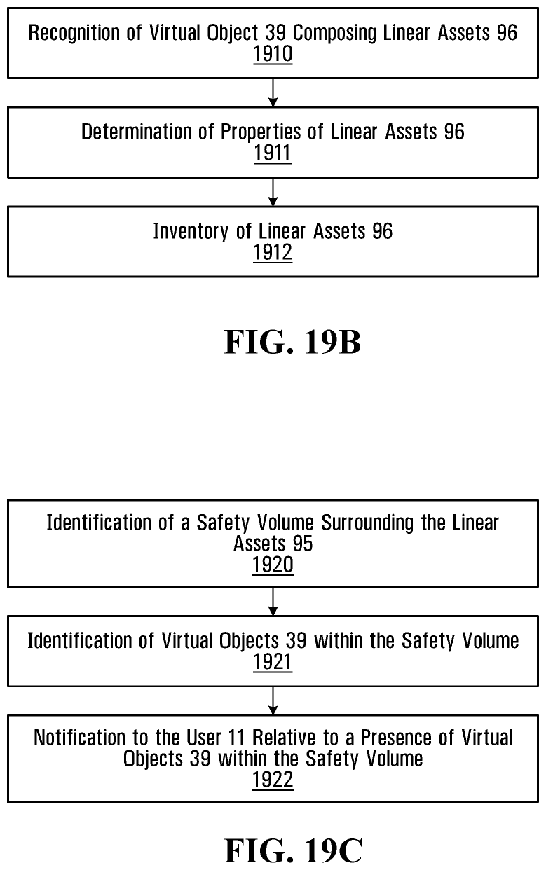

With additional reference to FIG. 21, a possible approach to identify roofs 112 that need repair is to first perform image processing to identify roofs in the scene (which assumes that a previous step of object classification has been performed to identify roofs in the image) and then search in the image area that correspond to roof surface discontinuities or isolated spots corresponding to missing shingles. Normally, shingles create a visually uniform surface. When shingles are missing as a result of aging, the underlying structure shows, and is likely to be visually distinct from the surrounding visually uniform surface created by the shingles. Such a distinction allows the software 62 to detect missing shingles by processing pixels of the image data component 65₁ to identify discontinuities 116. As a possible refinement, the software 62 is configured to classify the discontinuities 116 of the roof 112, for example depending on an estimated cause of the discontinuities 116 considering their number and distribution—aging, visual effect of the roof. For example, discontinuities 116 that are too large may be atypical. A more typical size of discontinuity 116 showing signs of aging is about the size of a single shingle or a pair of shingles. As another example, if the discontinuities 116 are too regularly distributed, the discontinuities 116 are likely caused by a visual effect of the roof 112 instead of being caused by missing shingles. Once an aging roof has been identified, the logic can compute the surface to allow a quick determination of the price for repair.

The software 62 is configured to implement a threshold to identify roofs, which are in need of repairs from those unlikely to be in need of repairs. The threshold is determined based on the factors above, namely level of visual uniformity of the roof surface, and size and distribution of discontinuities. The threshold may be set at different levels depending on the intended application.

A similar approach can also be used on roofs 112 covered by metal panels. Aging of such roofs 112 may cause oxidation of the metal panels and oxidized panels may need maintenance and/or replacement. Oxidation usually shows visually on panels and such showing allows the software 62 to detect oxidized panels by processing pixels of the image data component 65₁ to detect colors characterizing oxidation and/or identify discontinuities 116.

Note that the image processing of the roof to determine if it is in need of repairs requires a roof that is clear of snow or other debris or more generally the environmental conditions must be such that there is a low probability of image artifacts, which can produce false results. Accordingly, the image processing operation may require as an input factors such as the season during which the scan is performed (prevent the processing during the winter period) or the environmental conditions during the scan. If rain is present or the visibility is poor, the processing will not proceed or it can be deferred until a scan is performed at a time where the visibility is satisfactory and there are no snow build-ups on the roof.

In some embodiments, computation of the surface area 114 is an approximation since all sides of the roof 112 are not likely to be captured during scan. The computation may comprise a step of characterization of the roof 112: for instance, some buildings have roofs 112 having four sides, while some roofs 112 only comprise a front side and a back side. The software 62 may be configured to assume that each of the four sides of the roof 112 are of the same size, i.e., have the same surface area 114, or that each of the front and the back sides of the roof 112 have a same size, i.e., have the same surface area 114, depending on the type of roof 112 that is being scanned.

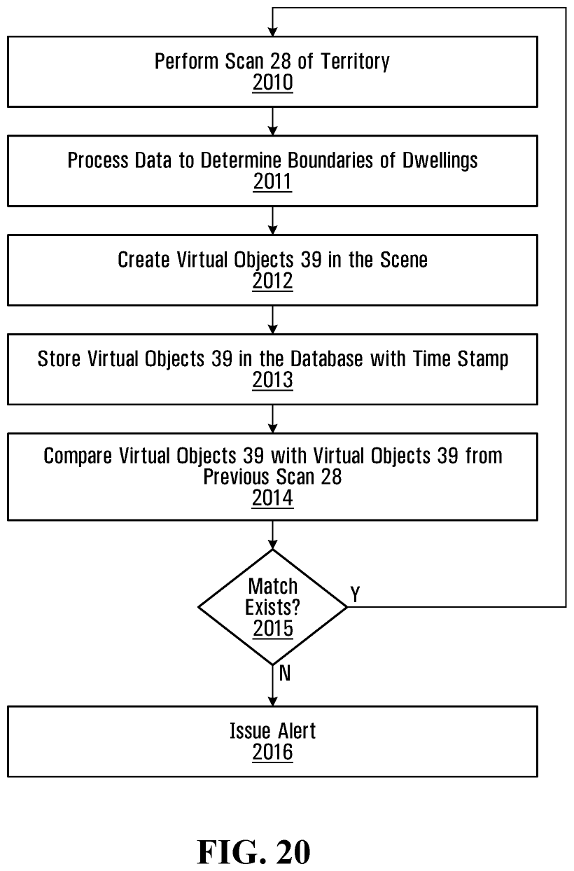

Assuming the curated data 64 adequately describes a side 108 of the roof 112, the software 62 may use the image data component 65₁ and/or the Lidar data component 65₂ of the curated data 64 to compute an inclination of the side 108 of the roof 112 and subsequently a surface area 114 of the side 108 of the roof 112. Since the image data is a plain view of the roof, the inclination information from the Lidar is useful to determine with greater accuracy the surface area. If other sides 108 of the roof 112 are depicted by the image data component 65₁ and the Lidar data component 65₂ of the curated data 64, the surface area 114 may also be computed for these sides, and subsequently the surface areas 114 of sides that are not depicted by the curated data 64 may be approximated. Optionally, the software 62 may use a subset of the Lidar data component 65₂ of the curated data 64, which corresponds to an image of the roof 112 in the image data component 65₁ of the curated data 64, to create a virtual three-dimensional representation of the roof 112, and comprising one side or multiple sides. The software 62 may then use the virtual three-dimensional representation of the roof 112 to compute the surface area 114 of the roof 112. With additional reference to FIG. 22, yet another option is for the software 62 to interface with a satellite imaging software that provides a top view of the roof 112, hence avoiding the necessity to resort to the assumptions regarding the surface area 114 of sides 108 of the roof 112 that are not depicted by the curated data 64. Google Earth is an example of such software. The software 62 may interact with the satellite imaging software by processing the curated data 64 of the roof 112, computing GPS coordinates of the roof 112, and inputting the GPS coordinates of the roof 112 into the satellite imaging software. The satellite imaging software may a bird's-eye view of the roof 112, allowing the software 112 to estimate the surface area 114 of a side of the roof 112 that is unseen from the scan, for example a back side, relative to the surface area 114 of a side of the roof 112 that is seen from the scan. Because the side of the roof 112 that is seen from the scan 28 has a surface area being known from the software 62, it is possible for the software 62 to more accurately estimate the surface area 114 of the entire roof 112 being seen from the scan 28.

In this embodiment, the software 62 may notify the user 11 of roofs 112 in the scanned territory that may be aging such that, for instance, a representative can be dispatched to pro-actively offer roof repair services to the owner of houses having aging roofs. At the same time, a price estimate can be preliminarily prepared based on the assessed surface area 114 of the roof 112. In this fashion, the representative can be able to provide to the owner a complete proposal for services. For instance, the price estimate may be based on a price per unit area, which is then multiplied by the approximated surface area of the roof to determine the cost estimate.

While in this example the service provided relates to roofing maintenance, the software 62 can be used for any purpose with a similar approach, such as, for example: to identify buildings requiring a paint job and estimate an area of surface of the paint job; to identify driveway entrances requiring resurfacing and estimate an area of surface of the resurfacing; to identify windows showing signs of aging; to identify masonry works, such as building walls, showing signs of aging; etc.

2) Temporary Driveway Canopy

In northern climates, it is popular for home owners to use a temporary canopy 120 to cover a driveway during winter periods and avoid a need of shoveling or otherwise removing snow from the driveway. A popular option for home owners wanting to use such a canopy 120 is to rent the canopy 120 instead of purchasing the canopy 120. A rental service typically provides installation of the canopy 120 before the start of a winter period, and removal of the canopy 120 at the end of the winter period.

In some embodiments, the software 62 is used to identify among the virtual objects 39 of the virtual scene 37 canopies 120 that have been installed in order to derive a population of renters. In turn, a user, which can be a new entrant in the canopy renting business may offer a competing service or a complementary service or derive a population of potential renters that are not using any canopy yet. As such, the software 62 may output, for example, a list of potential clients, their addresses, their location on a map, and their status (e.g., renting a canopy 120 from a competitor, not using any canopy 120 yet, etc.).

In some embodiments, also, the software 62 is part of a platform allowing users, being in this case providers of canopies 120, to access a list of potential clients and information relative to such potential clients. For example, if the user 11 is a new user of the platform, the software 62 may inform the user 11 of every address having a removable canopy 120, each of these addresses representing a potential client. A particular brand of canopy can be identified by recognition of alphanumeric characters on the canopy. That recognition can be performed through Optical Character Recognition (OCR) techniques. Accordingly, in addition to the simply identifying presence and location of canopies 120, the software 62 through brand/marking presence can further classify the canopies 120 in sub-groups according to a manufacturer or rental service of the canopy 120. Accordingly, a user 11 can identify among the entire installed base of canopies 120, the ones that the user 11 has provided from those that have been provided by competitors. An output of the software 62, in this case, can be a list and/or a map, providing a number of canopies 120 each provider has in the territory and further location each of the canopies 120. Therefore, the software 62 may provide the user 11 with data such as market share, market penetration, density maps, etc.

3) Snow Clearing Services

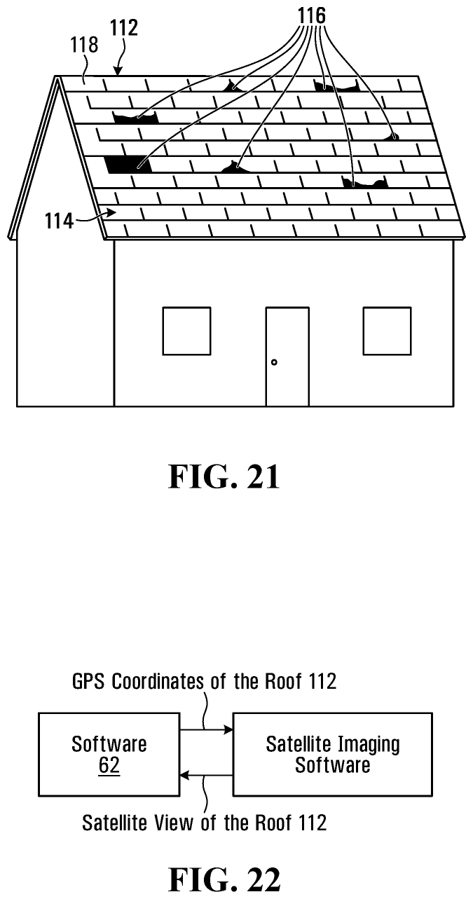

In northern climates, it is necessary for home owners and industries to clear the driveways 130 of snow during winter periods. In these circumstances, it is popular for home owners and industries to rely on snow removal service providers to clear the driveways 130. The snow removal service providers often mark the driveways 130 or areas to clear with recognizable markings 132, such as posts on each side of the driveway 130, to be able to easily see in a residential street the properties that have subscribed to the service and that need to be cleared, as shown in FIG. 23.

These recognizable markings 132 which tend to be of recognizable shape with alphanumeric characters 134, which can denote a phone number of the snow removal service and/or a name of the snow removal service. In some embodiments, the software 62 may recognize the signs in the virtual scene 37 and associate each sign and each driveway delimited by the signs to a snow removal service provider. The software 62 may accomplish a step of characterization wherein each driveway 130 of the virtual scene 37 is characterized (by a location, by a driveway surface area, by a snow removal service provider, etc.) and wherein data is derived from the classification in order to provide market share data, market penetration data, etc., to users 11 of the software 62. In this case, users 11 of the software 62 may comprise, for instance, snow removal service providers subscribing to the software 62.

4) Roadway Repair Services

In northern climates, potholes often develop on roadways during winter and spring periods through freeze/thaw action. Potholes are created when water, because of snow and ice thaw, seeps under pavements and subsequently freezes again, turning into ice and lifting the pavement. When the ice thaws and disappears, it leaves a hole under the pavement that collapses as vehicles pass over it. When the potholes become too large and too deep, they create a safety hazard in addition to presenting other risks, such as blowing a tire or damaging a wheel of a car.

In some embodiments, roadways may be managed by the software 62. The software 62 may identify potholes 142 in the scene 37 and classify the potholes 142 in terms of severity depending on pre-determined parameters such as width, length, depth, location, etc. In most cases, the most important parameter is depth: once width and length of the pothole 142 exceed a certain dimension, sufficient for a wheel of a vehicle to enter the pothole 142, the depth of the pothole 142 determines the likelihood and severity of damage to the vehicle and an attendant security risk to occupants of the vehicle. The software 62 may further identify the potholes 142 requiring immediate repairs and determine a due date for reparations of the other potholes 142.

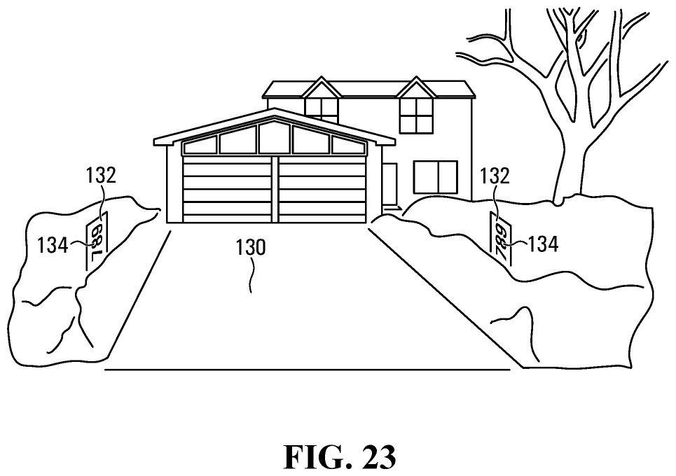

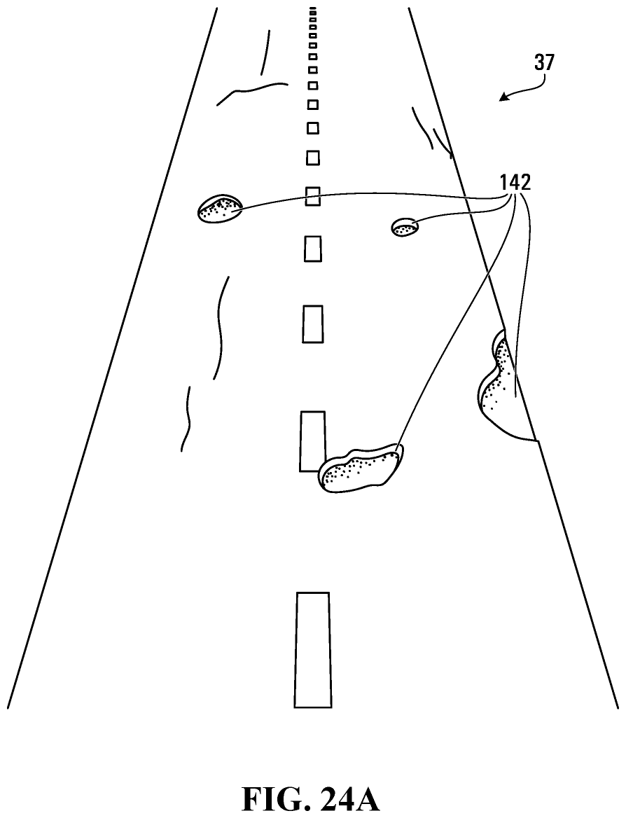

With additional reference to FIG. 24, in some cases, the software 62 may function by accomplishing a first step 2410 of processing the image data component 65₁ of the data 64 to find signatures of potholes 142. For instance, the signature of potholes may comprise an irregular shape appearing on the roadway. Normally, roadways create a visually uniform surface. When potholes 142 appear, layers under the pavement appear and are likely to be visually distinct from the surrounding visually uniform surface created by the roadway. At step 2411, the software 62 may process the Lidar data component 65₂ of the curated data 64 about the irregular shape appearing on the roadway to assess if the irregular shape corresponds to a pothole 142. If the Lidar data component 65₂ of the curated data 64 shows a surface of the roadway is generally continuous, the signature detected at step 2410 is classified as being an artifact in opposition to a pothole 142; if the Lidar data component 65₂ shows a recess on the roadway, then the signature detected at step 2410 is classified as being a pothole 142. Alternatively, step 2410 may be absent and potholes 142 may be found only using the Lidar data component 65₂ of the curated data 64. At step 2412, a size (e.g., width, length) and a depth of the recess determines how large the pothole 142 is and the size of the recess may be further used to classify the pothole 142, as discussed earlier. Accordingly, at step 2413, an output of the software 62 may comprise data characterizing the roadway in terms of presence of potholes 142. The characterization of the roadway allows organizing repairs in a structured and efficient manner, for example by identifying potholes 142 which are in need of repairs, or by ranking roadway segments from the potentially most dangerous segment due to potholes 142 to the potentially least dangerous segments due to potholes 142.

The software 62 is configured to implement a threshold, to identify potholes 142 which are in need of repairs from those unlikely to be in need of repairs. The threshold is determined based on factors such as the size (e.g., width, length) and depth of the recess, the location of the recess, etc. The threshold may be set at different levels depending on the intended application.

Alternatively, at step 2413, instead of simply listing data characterizing the roadway in terms of presence of potholes 142 to the user 11 in a context where the user 11 decides how to dispatch work crews, the software 62 can send notifications directly to work crews (e.g., over mobile devices) identifying levels of urgency, locations and other characteristics of the potholes 142. Optionally, the software 62 may provide the work crews with images of the potholes 142 such that they can be easily identified.

In contexts where scanning of the territory by a scanning vehicle 10 is performed within short intervals of time, such as every week or every three days, the software 62 may have a functionality that recognizes previously identified potholes 142 to avoid duplicating an alert for the same condition. Similarly, the software 62 may monitor roadways and potholes 142 by informing the user 11 which pothole 142 has been repaired during each period of time, providing the user 11 with data such as, for example, average repair times of potholes 142 in different areas of territory, average durability of potholes 142, number of repairs per day, etc. In this example, the scan of the scene is performed and the software 62 identifies the potholes 142 on the road, as discussed previously. The software 62 may then compare the potholes 142 of the scan 28 to the potholes of an immediately previous scan. This comparison between consecutive scans has a three-fold purpose:
(1) Confirm that potholes 142 that are marked as repaired in a given record are indeed repaired;
(2) Identify potholes 142 that are deteriorating more rapidly than expected, such as to proactively predict future conditions of the roadways; and
(3) Identify new potholes.

This three-fold purpose may be achieved by different ways. For example, in embodiments where the software 62 can dispatch work assignments to the work crews after potholes 142 have been automatically identified and characterized by the software 62, once the work crew has finished repairing a pothole 142, the work crew may report back that the work is completed by inputting information into the software 62. In some cases, the completion input is an electronic communication (e.g., email) that is replied to an electronic communication delivering the work notice. In other words, the work notice may be transmitted to work crews by email as previously discussed and work crews may confirm that the work is completed by replying to the email accordingly. The software 62, upon reception of notice acknowledging completion of work, logs data against the pothole 142 and marks it a fixed.

When a new scan 28 is completed and the output of the new scan 28 is available, the software 62 first correlates outputs of the two scans 28 and matches potholes 142. For potholes 142 in the earlier list, marked as being repaired, the software 62 verifies in the data 64 of the new scan 28 that there is no pothole at specific locations of the earlier potholes 142. If none is seen, the logged data against the potholes 142 and the “fixed” mark associated with the potholes 142 are confirmed, and the potholes 142 may be permanently deleted from the list provided by the software 62. Potholes 142 provided by the software 62 using the new scan 28 are then matched to potholes 142 of the previous list of potholes 142 and their characteristics, provided by the software 62 using the older scan. The matching is accomplished to observe evolution of the potholes 142 and to observe new potholes 142. To observe the evolution of the potholes 142, the software 62 may compare pre-determined characteristics such as size and depth of matched potholes 142 provided by either one of the image data and the Lidar data. The software 62 may then compute a rate of growth of the pothole 142 using the previous scans. The rate of growth may be defined by a variation of the characteristics of the pothole 142, such as the size and depth, over time. Above a certain rate of growth, the pothole 142 may be evaluated by the software 62 as being urgent matter and the software 62 may dispatch a work crew to repair the pothole 142. In the evaluation, the software 62 may consider different parameters, such as the size and depth, the rate of growth of the potholes 112 and expected delays of repairing, etc. As such, even if the pothole 142 does not have a size that warrants putting it as an urgent matter, the software 62 may take into account delays for the repair crew to fix the pothole 142, such that, in order to prevent the pothole 142 from reaching the critical point at which the pothole will be considered as being an urgent matter, the software 62 computes that a work dispatch is required. Accordingly, the software 62 may output a notice for repair with a due date corresponding to the projected time at which the pothole 142 will reach the critical point. Potholes 142 having no significant deterioration may remain non-urgent and may be repaired after the urgent ones.

While in this example the service provided concerns roadway repair services and, more specifically, potholes 142, the software 62 may be used for any purpose with a similar approach, such as, for example: to identify and follow the evolution of damages (e.g., cracking, spalling, fire damage, alteration of phases, missing tiles, etc.) on structures such as bridges, damns, buildings, ships, tunnels, railroads, pipelines, etc.;

5) Autonomous Vehicles

To safely and securely transit from a place to another, autonomous vehicles require a great amount of data about immediate environments of the vehicles at any time. This great amount of data can be procured by sensors disposed around the vehicle. However, sensors provide the autonomous vehicle with real time data that requires to be processed at a very high speed, thus requiring high processing capabilities that cannot be provided by processing systems of the autonomous vehicles or that render the processing systems of the autonomous vehicles too expensive or too consuming. Additionally, the readings of the sensors may be corrupted by a plurality of factors, such as a brightness of the immediate environments, weather conditions, and the like.

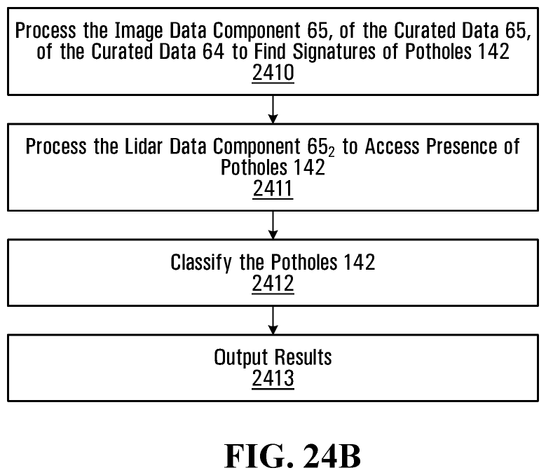

In another example of implementation, the software 62 may be used to facilitate navigation of an autonomous vehicle 150 by providing a scan 28 of an area to the autonomous vehicle 150 before or while the autonomous vehicle 150 circulates in the area. As shown in FIGS. 25A and 25B, the key components of the navigation system 152 of the autonomous vehicle 150 that generates the real-time data include a camera 153, a Lidar 154 and a GPS 155 whose outputs feed into a control system 156. The control system 156 is an entity of the autonomous vehicle 150 taking navigational decisions based on the output of the sensors 153-155, among others. The control system 156 is a computerized platform that executes a software and outputs navigational signals. The navigational signals comprise throttle commands, brake commands and steering commands. In addition to the real-time information input into the control system 156 by the sensors 153-155, the control system 156 also receives the virtual scene 37, which is derived from the scan 28. The virtual scene 37 is used in conjunction the real-time information to provide a more precise understanding of the surroundings of the vehicle 150 and to reduce the required processing capabilities of the control system 156.

Optionally, the autonomous vehicle 150 may comprise a plurality of any one of the sensors 153-155. In some cases where the autonomous vehicle 150 comprises a plurality of cameras 153, a configuration of the cameras 153 may allow the control system 156 of the autonomous vehicle 150 to execute photogrammetry of the immediate environment of the vehicle in order to obtain a three-dimensional virtual scene 37 derived solely from the output of the cameras 153 and/or in order to refine the virtual scene 37 otherwise obtained. A non-limiting example of such a configuration is provided in U.S. Pat. No. 9,229,106, which is enclosed herein by reference.

The control system 156 receives both the real-time data and pre-scanned data, which has been derived from the scan 28 of the territory in which the vehicle is anticipated to circulate. Collectively, the combination of real-time data and the pre-scanned data provide a robust set of navigational information to allow autonomous driving.

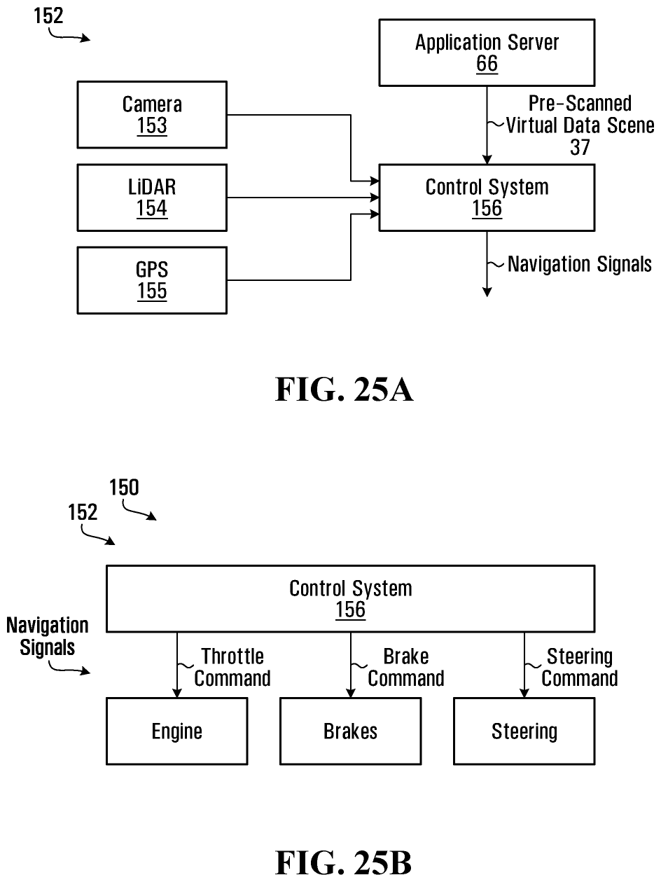

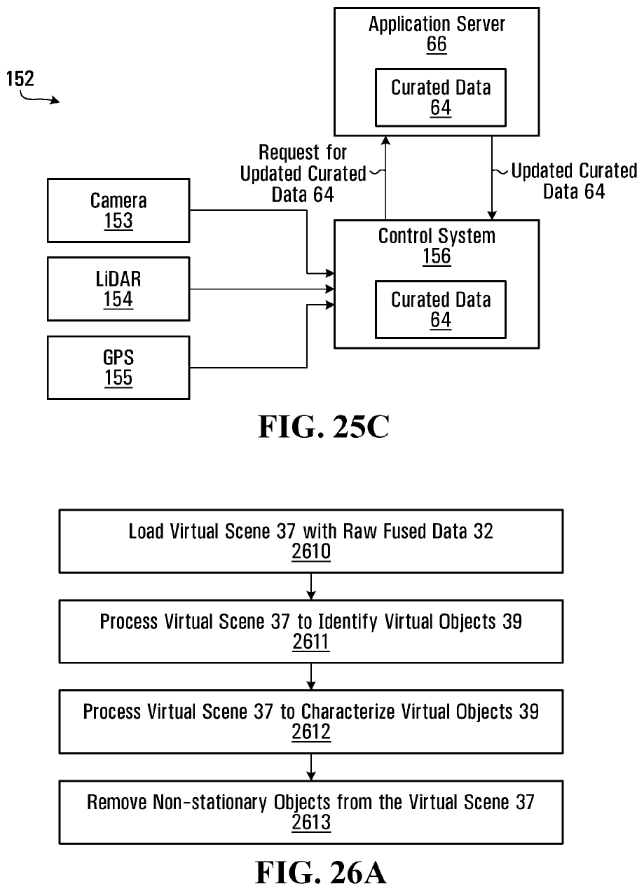

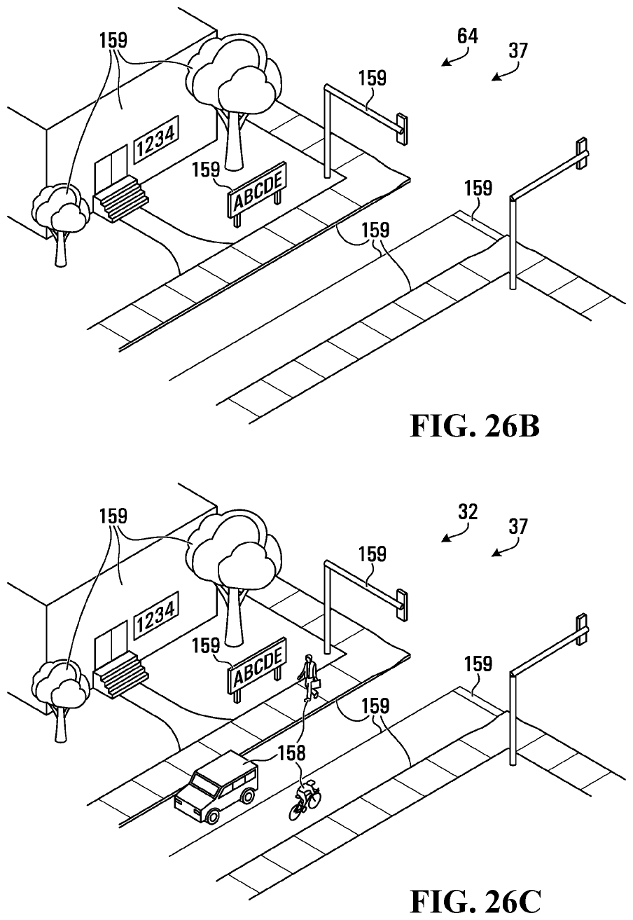

The pre-scanned virtual scene 37 is generally obtained as described previously and depicted in FIGS. 3A and 3B: the scanning vehicle 10 collects the image data stream 27₁, the Lidar data stream 27₂ and the GPS data stream 27₃ and correlates them into a common, raw fused data set 32. The raw fused data 32 forms the virtual scene 37 comprising the virtual objects 39. The raw fused data set 32 is then curated into the curated data 64 to make it suitable for use by the autonomous vehicle 150. Accordingly, curating may, in some cases, remove some of the virtual objects 39 from the virtual scene 37 and thus, the virtual scene 37 formed by the curated data 64 may be different than the virtual scene 37 formed by the raw fused data 32. As shown in FIG. 26, in this case curating comprises steps 2610, 2611, 2612, 2613, and is configured to identify non-stationary objects 158 among the virtual objects 39 and remove the non-stationary objects 158 from the virtual scene 37. Non-stationary objects 158 are objects that are either moving when the scan takes place or of a nature such that they are expected to move instead of remaining stationary. Because the virtual scene 37 is captured prior to a passing of the autonomous vehicle 150, the non-stationary objects 158 will likely have moved from their initial locations and will probably not be there when the autonomous vehicle 150 will be. Examples of non-stationary objects 158 include vehicles, motorcycles, pedestrians, cyclists, animals, etc. In effect, it may be counterproductive to provide data including non-stationary objects 158 to the control system 156, because non-stationary objects 158 are not relevant to the decision-making process of autonomous navigation.

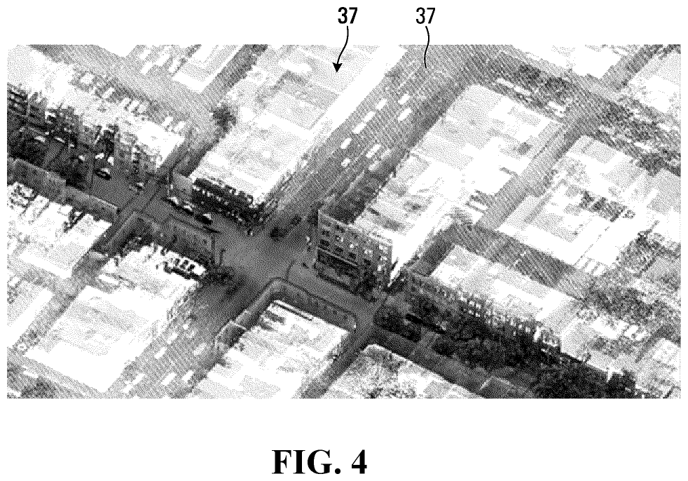

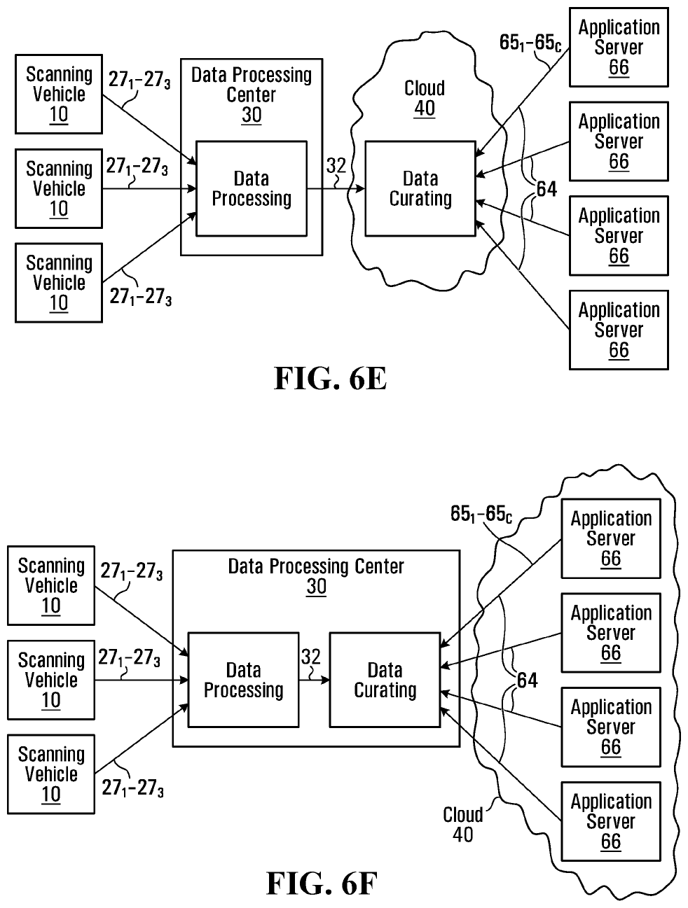

Identifying the non-stationary objects 158 among the virtual objects 39 and removing the non-stationary objects 158 from the virtual scene 37 may be done by any suitable means. For example, in some embodiments, the identifying the non-stationary objects 158 may be done by the AI layer 63 of the software 62 and the AI layer 63 may be trained to recognize non-stationary objects 158 among the virtual objects 39, using the image data component 34 of the raw fused data 32. The process of recognizing non-stationary objects 158 is similar to the process of recognizing other virtual objects 39, as discussed previously and depicted in FIGS. 4 to 8. In a specific example, the non-stationary objects can include automobiles and pedestrians. The AI layer 63, trained to classify automobiles and pedestrians can reliably identify those in the image and remove them from the image.

Stationary objects such as roadways, curbs, road obstacles and detours (closed roads or closed streets), among others, are relevant to the control system 156 and are retained among the virtual objects 39 of the virtual scene 37.

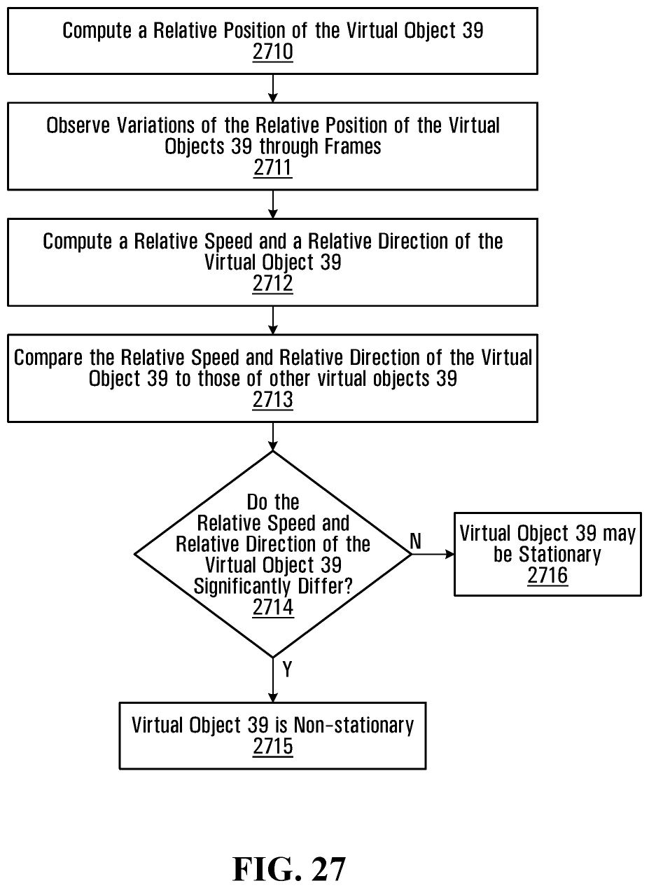

Optionally, with additional reference to FIG. 27, the AI layer 63 may estimate a relative speed and a relative direction of each virtual object 39 of the virtual scene 37. This may be accomplished at step 2710 by computing, for each virtual object 39, a position relative to the autonomous vehicle 150. At step 2711, the AI layer 63 observes variations of the positions of the virtual objects 39 through measures of the camera 22 and Lidars 24, and accordingly, through time. At step 2712, the AI layer 63 computes a speed and a direction for each of the virtual objects 39 relative to the autonomous vehicle 150. At steps 2713, 2714, 2715 and 2716, the relative speed and direction of each of the virtual objects 39 is compared to the relative speeds and directions of the other virtual objects 39: if the speed and directions of a particular virtual object 39 substantially differ, then the particular virtual object 39 is considered to move relative to its environment, i.e., to be non-stationary. Otherwise, the particular virtual object 39 is categorized as being potentially stationary.

Alternatively, instead of comparing the relative speed and direction of each of the virtual objects 39 to the relative speeds and directions of the other virtual objects 39, the AI layer 63 compares the relative speed and direction of each of the virtual objects 39 to the speed and direction of the autonomous vehicle 150. If the speed of a particular virtual object 39 is the same as the speed of the autonomous vehicle, but in an opposite direction, then the particular virtual object 39 is categorized as being potentially stationary. Otherwise, it is considered to be non-stationary.

In some cases, the AI layer 63 may observe the variations of relations between the speed and direction of each of the virtual objects 39 and the speed and direction of the autonomous vehicle 150 through time. If the relations between the speed and direction of a particular virtual object 39 and the speed and direction of the autonomous vehicle 150 change through time, then the particular virtual object 39 is categorized as being non-stationary. If the relations do not change, the particular virtual object 39 is categorized as being potentially stationary.

Once identification of the non-stationary objects 158 among the virtual objects 39 is done, the AI layer 63 may remove those virtual objects 39 from the virtual scene 37 by simply removing the image data component 34 and the Lidar data component 35 corresponding to the non-stationary objects 158 from the raw fused data 32.

In some embodiments, as a possible refinement, the software 62 may predict the likelihood of certain encounters around specific locations. In this example, prior to removing the non-stationary objects 158, the software 62 further categorizes them and computes a probability that different types of non-stationary objects 158 may be encountered at each specific location, using the previous records. For example, the software 62 may categorize the non-stationary objects 158 as being vehicles, motorcycles, pedestrians, cyclists, animals, etc., and furthermore categorize them, for example as being a police car, a police officer, a taxi, an ambulance, etc., using similar methods as previously described. The software 62 may then produce index data indicating that a certain type of virtual object 39 has been located around a particular location. The software 62 may preserve this data during curating, while the virtual object 39 referred by the index data is removed. Using the previous scans 28 of the territory and the index data produced therein, the software 62 may compute a probability that the autonomous car 150 will encounter the same type of non-stationary object 158 around the same location. For instance, police cars and police officers may be found around the same spots, for example, for tracking speed of vehicles passing by; the probability computed by the software 62 that the autonomous vehicle 150 encounters a police car or a police officer around these spots is high. Also, in some cases, pedestrians may cross the street more often in certain spots, such as on a crossing, than in other spots; the probability computed by the software 62 that the autonomous vehicle 150 encounters a pedestrian around these spots is high. Depending on the probability that is computed by the software 62 and provided to the control system 156, the control system 156 may limit a speed of the autonomous vehicle 150 when it approaches one of the various spots.

Some of the stationary objects 159 are semi-permanent, i.e., may be removed after a certain duration, and may not appear on regular roadway maps. During autonomous navigation, the autonomous vehicle 150 is likely to encounter such semi-permanent objects and accordingly needs to recognize them in order to properly navigate. In addition to this, real-time recognition of the semi-permanent objects may be challenging and may produce unsafe conditions for navigating or, simply confuse the control system 156. Accordingly, in some embodiments, semi-permanent objects may be retained among the virtual objects 39 of the virtual scene 37 during curation of the raw fused data 32.

In some embodiments, curating may comprise a further step of separating the data components 65₁-65₃, such that each of the data components 65₁-65₃ may be used individually and independently of each other, in order to facilitate processing the data by the control system 156 of the autonomous vehicle 150. For example, this may ease superposition of the output of the camera 153 and superposition of the output of the Lidar 154 over the curated data 64, and therefore allow better correlation with the real-time information captured by the sensors 153-155 of the autonomous vehicle 150. This step may be done after removal of non-stationary objects 158 from the virtual scene 37 at step 2613. In some cases, the image data component 65₁ may be provided in a raster format or preferably in a vector graphics format that reduces a bandwidth of the image data component 65₁. The Lidar data component 65₂, which is essentially a point cloud modified to remove the non-stationary objects 158 from the virtual scene 37, can be sent as such, in other words as a point cloud representation. Alternatively, the virtual objects 39 in the point cloud can be distinguished from each other and separately identified to simplify processing of the Lidar data component 65₂ and the output of the Lidar 154 by the autonomous vehicle 150. For example, the point cloud of the virtual scene 37 may define boundaries of the virtual object 39 that has been previously characterized by the AI layer 63 of the software 62, and the AI layer 63 may tag the virtual object 39 with its characteristics conveying meaningful information. For example, if there is a road closure, a virtual object 39 may be characterized as a detour sign and a tag depicting this characteristic may be associated with the point cloud of the virtual object 39 while it is separated from the rest of the point cloud of the scene 37. As such, the detour sign is identified by the tag instead of simply showing up as a road obstruction.

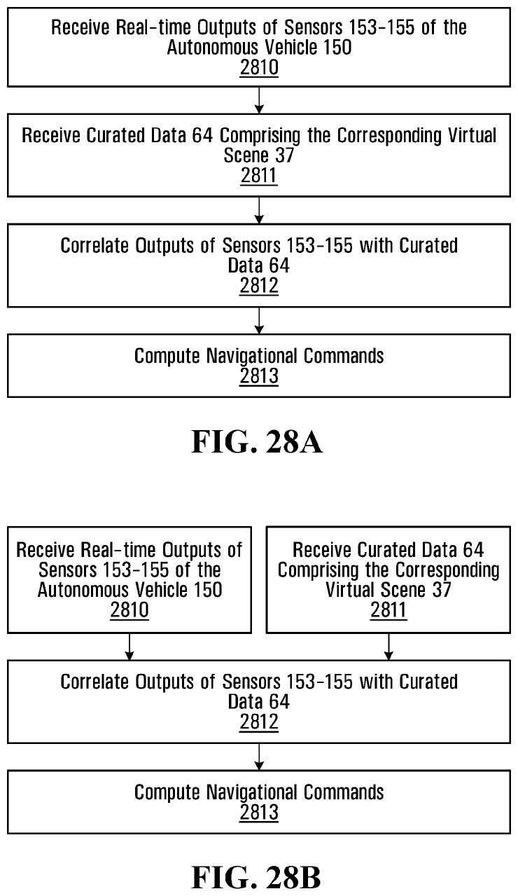

With additional reference to FIGS. 28A and 28B, the control system 156 processes and correlates flows of information provided by the sensors 153-155, which are real-time data flows, and flows of information provided by the scan 28. The correlation process essentially consists of identifying relevant virtual objects 39 in the virtual scene 37 depicted by each data flow and matching them to each other. When a successful match is achieved, the control system 156 may have greater confidence that the immediate environment of the autonomous vehicle 150 is correctly interpreted. Accordingly, at step 2810, the control system 156 receives real-time outputs of sensors 153-155 of the autonomous vehicle 150, which correspond to the first flow of information mentioned above. At step 2811, the control system 156 receives the curated data 64 comprising the virtual scene 37 corresponding to the immediate environment of the autonomous vehicle 150. The data 64 may be obtained by one or many scans 28 previously made by the scanning vehicle 10, and corresponds to the second flow of information mentioned above. At step 2812, the control system 156 correlates the real-time outputs of sensors 153-155 of the autonomous vehicle 150 with the data 64, allowing the control system 156 to take navigational decisions and compute navigational commands at step 2813.

The correlation of step 2812 may involve, on one hand, correlating image data between two image streams, i.e., the output of the camera 153 and the image data component 65₁ of the curated data 64, and on the other hand, correlating Lidar data between two Lidar streams, i.e., the output of the Lidar 154 and the Lidar data component 65₂ of the curated data 64.

On one hand, the control system 156 verifies that both image streams are substantially identical or that both image streams depict the same environment. The verification may be accomplished by any suitable way. For example, the control system 156 of the autonomous vehicle 150 may observe in both image streams colors, changes in colors, textures, etc., and superpose the image streams to compute a probability that the image streams effectively match. Optionally, the control system 156 may comprise an AI for object recognition having a working principle similar to the AI layer 63 discussed earlier, and recognize objects of both image streams which may then be compared to each other to compute a probability that the image streams effectively match. The control system 156 is configured to implement a threshold to identify whether objects of both image streams match or don't. The threshold may be set at different levels depending on the intended application. If the probability is above the threshold, the image streams are considered to match—this should be the case if the received output of the camera 153 is correct and adequately shows the immediate environment of the autonomous vehicle 150. If there is a non-match between the two image streams, this may indicate a malfunction of the camera 153 and/or of the control system 156. For instance, the camera 153 of the autonomous vehicle 150 may be misaligned and/or misoriented. Optionally, the curated data 64 comprising the virtual scene 37 corresponding to the immediate environment of the autonomous vehicle 150 may not correctly register with the movements of the autonomous vehicle 150; for instance, the curated data 64 may convey one of the virtual scenes 37 that the autonomous vehicle 150 has already passed or one of the virtual scenes 37 that has not yet been reached by the autonomous vehicle 150. Irrespective of the reason for the mismatch, the control system 156 performing the correlation of step 2812 may output an error signal and/or defaults the autonomous vehicle 150 to a safe mode such as, for example, initiating a safe stop and/or disabling the autonomous mode, i.e., requiring a driver to function.

On the other hand, the control system 156 verifies that both Lidar streams are substantially identical, or that both Lidar streams depict the same environment. The verification may be accomplished by any suitable way and may be accomplished in a similar manner as the verification regarding image streams discussed above. For instance, the output of the Lidar 154 may consist of a series of optical signal returns which are interpreted as obstacles and a distance of those obstacles relative to the autonomous vehicle 150 is assessed based on a time flight of the optical signal. In other words, the control system 156 can construct a three-dimensional representation of the environment based on those optical signal returns. Subsequently, the control system 156 of the autonomous vehicle 150 may observe the three-dimensional representation of the environment constructed from the output of the Lidar 154 and the corresponding virtual scene 37 of the curated data 64, to compute a probability that the Lidar streams effectively match. If the probability is above a pre-determined threshold, the Lidar streams are considered to match—which should be the case when the control system 156 is working properly under normal conditions. Matching Lidar streams may indicate that at least some objects of the immediate environment of the vehicle have been correctly identified by the Lidar 154. If there is a non-match between the two Lidar streams, that is, if the probability is below the pre-determined threshold, this may indicate a malfunction of the Lidar 154 and/or of the control system 156.

In the probable event the autonomous vehicle 150 has to deal with traffic, such as moving vehicles, moving cyclists, moving pedestrians and the like, a mismatch between the image streams and between the Lidar streams is likely to appear, without necessarily implying that the sensors 153, 154 and/or the control system 156 is operating incorrectly. Since the data 64 does not show non-stationary objects 158 and since non-stationary objects 158 of the immediate environment of the autonomous vehicle 150 are present in the real-time outputs of sensors 153, 154, mismatches may appear even in normal operating conditions. In some embodiments, the control system 156 is configured to distinguish between abnormal mismatches, i.e., mismatches that may indicate a malfunction of the sensors 153, 154 and/or of the control system 156, and normal mismatches, i.e., mismatches that are due to non-stationary objects 158 being removed during curating and/or to new objects 5 in the immediate environment of the autonomous vehicle 150. This may be accomplished by estimating in real time, in at least an approximate fashion, if the objects 5 in the immediate environment of the autonomous vehicle 150 that are detected by the sensors 153, 154 of the autonomous vehicle 150, are stationary or non-stationary, as previously discussed with regards to curating, and as depicted in FIGS. 26 and 27.

Moreover, non-stationary objects 158 may be more likely to appear in certain areas of the immediate environment of the autonomous vehicle 150, such as on roadways, sidewalks, etc., while objects appearing in other areas of the immediate environment of the autonomous vehicle 150 are more likely to be stationary. Accordingly, in some embodiments, the control system 156 may consider every mismatch appearing in the scene near roadways, sidewalks and the like as normal mismatches. Alternatively, the control system may compute the match or mismatch by only referring to the areas of the scene 37 where non-stationary objects 158 are less likely to appear, i.e., relatively far from the roadway, sidewalks, etc., and match stationary objects 159 159 such as infrastructures, traffic lights, and the like.

In some embodiments, the control system 156 only correlates image data between the two image streams and Lidar data between the two Lidar streams, computes the match or mismatch between the two image streams, and assumes that the two Lidar streams match, if the two image streams match. In other words, the control system 156 may assume that the two image streams and the two Lidar streams match or mismatch equally. Alternatively, the control system 156 may only compute the matching probability between the two Lidar streams and assume that the two image streams match if the two Lidar streams do.

When the two Lidar streams are assumed to match by the control system 156, by any suitable means as discussed above, the two Lidar streams may be overlaid one over the other, e.g., the real-time output of the Lidar 154 of the autonomous vehicle 150 may be overlaid over the Lidar data component 65₂, in order to create a fused Lidar stream. The fusing process may avoid redundancies by any suitable means. For example, in some cases, if a point of the real-time output of the Lidar 154 and a point of the Lidar data component 65₂ reside generally at the same location, the point of the real-time output of the Lidar 154 may be ignored by the fusing process, such as to avoid having two Lidar data points in the fused data stream that provide similar information. On the other hand, if a point of the real-time output of the Lidar 154 resides closer to the autonomous vehicle 150 than a corresponding point of the Lidar data component 65₂, i.e., a point in the same direction relative to the autonomous vehicle 150, then the point of the real-time output of the Lidar 154 may be retained as it may indicate objects 5 that the autonomous vehicle must avoid.

One of the consequences of using the Lidar data component 65₂ generated using the one or antecedent scans 28 is that the Lidar data component 65₂ complements the real-time outputs generated by the sensors 153, 154 on board of the autonomous vehicle 150 and it has a resolution that may be greater than a resolution provided by the Lidar 154. Moreover, this allows using the Lidar 154 of a lesser precision and/or of a lesser resolution, hence less expensive. Also, in this configuration, the control system 156 may use the two Lidar streams and/or the fused Lidar stream, having different resolutions in different areas of the virtual scene 37. Static objects, which often describe boundaries of the roadway, may be described by the Lidar data component 65₂. Accordingly, in this fashion, boundaries if the roadway such as curbs, ramps, entrances, etc., are supplied at high resolution, allowing the control system 156 to make proper navigational decisions.

In some embodiments, also, the real-time output generated by the camera 153 may be used to detect non-stationary objects 158 by using AI, as discussed earlier. When non-stationary objects 158 are found in the immediate environment of the autonomous vehicle 150, a command may be provided to the Lidar 154 to scan in more details the immediate environment of the autonomous vehicle 150 in directions corresponding to the non-stationary objects 158. This may be done by suitable means, such as, for example, the ones described in U.S. Pat. No. 8,027,029, which are herein incorporated by reference.

The virtual scene 37, comprising the virtual objects 39, is intended to be updated as quickly as possible in order to represent the territory as accurately as possible. Accordingly, the curated data 64, including the image data component 65₁, the Lidar data component 65₂, and the GPS data component 65₃, should be updated in the autonomous vehicle as soon as updates are available. In some embodiments, only one or two of the data components 65₁-65₃ may be updated at the same time, i.e., if some of the data components 65₁-65₃ do not require an update, they may be spared. This also means that scans 28 of the territory need to be updated on a regular basis, as in some cases the scans 28 may be required to provide the data composing the virtual scene 37.

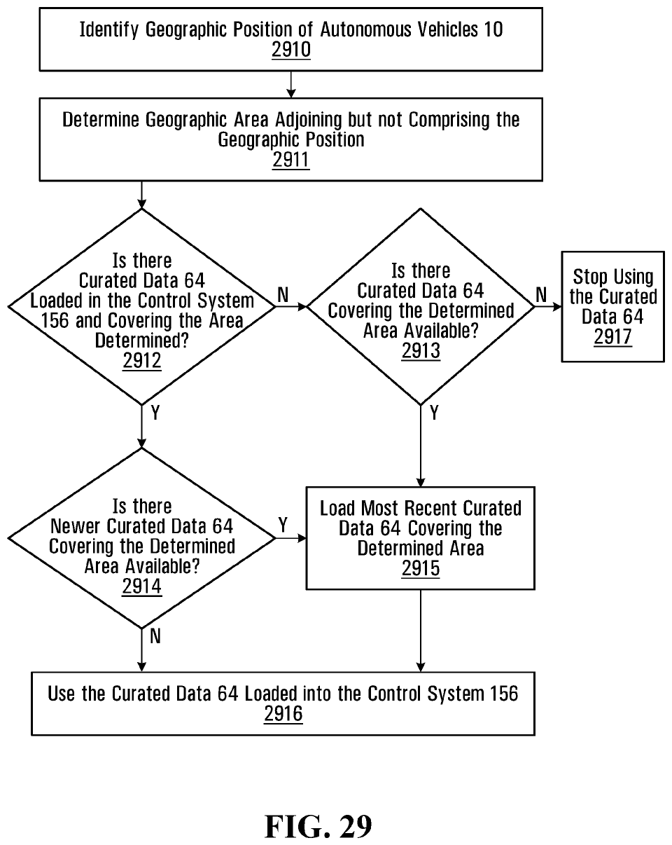

With additional reference to FIG. 29, in some embodiments, the data 64 is supplied and dynamically updated in segments, according to a location of the autonomous vehicle 150. In other words, the control system 156 of the autonomous vehicle 150 may constantly fetch data 64 that provides coverage over the area of territory where the autonomous vehicle 150 is moving. At step 2910, the control system 156 may identify a geographic position of the autonomous vehicle 150, using, for example, the GPS receiver 155 being on-board. At step 2911, as the autonomous vehicle 150 is traveling, the control system 156 may determine the area of territory over which coverage is necessary, based on a direction and speed of travel of the autonomous vehicle 150. The determined area, in most cases, is adjoining the geographic position of the autonomous vehicle 150, but does not comprise the geographic position. At step 2912, the control system 156 may verify if the data 64 already loaded and stored into the control system 156 provides coverage over the determined area. If it does, the control system 156 may proceed to step 2914, at which point the control system 156 may verify if there is an update available for the curated data 64 covering the determined area. If no update is available, the control system may use the curated data 64 loaded in the control system for navigation, which is step 2916; if an update is available, the control system 156 may load the most recent data 64 covering the determined area, which is step 2915, and then proceed to step 2916. If the data 64 already loaded and stored into the control system 156 does not provide coverage over the determined area, the control system 156 may proceed to step 2914, at which point it verifies if there is available data 64 that does provide coverage over the determined area. If data 64 covering the determined area is available, the control system 156 may then proceed to step 2915, and subsequently to step 2916. If no data covering the determined area is available at step 2913, the control system 156 may stop using the data 64 while the autonomous car 150 enters the determined area, which is step 2917.

While in some case the curated data 64 provided in an update includes the entire virtual scene 37 comprising the virtual objects 39 of the area of territory, in some embodiments, updates may only comprise a part of the virtual scene 37 that has changed since a previous version, and a remaining part of the virtual scene 37 that has not changed since a previous version is not comprised in the update. When it receives the update, the control system 156 may replace the older part of the virtual scene 37 by the new part provided by the update and leave the remaining part of the virtual scene 37 unchanged. In some embodiments, updates may only comprise new virtual objects 39 of the virtual scene, and the control system 156 of the autonomous vehicle 150 may incorporate the new virtual objects 39 among the other virtual objects 39 of the virtual scene 37 in the curated data 64 while leaving the rest of the virtual scene 37 unchanged. In some embodiments, updates may also indicate former virtual objects 39 of the virtual scene 37, and the control system 156 of the autonomous vehicle 150 may simply remove the former virtual objects 39 from the virtual scene 37 in the curated data 64.

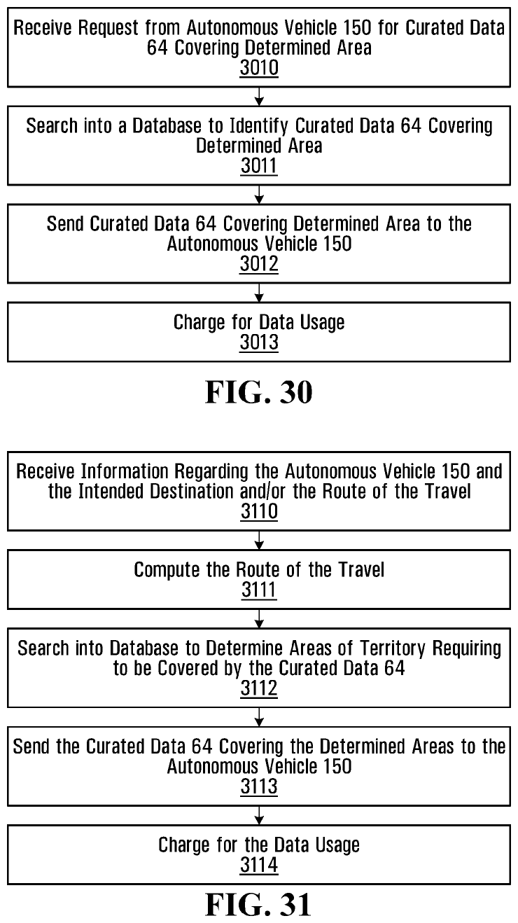

With additional reference to FIGS. 25C and 30, the control system 156 may communicate with a server 66 to know the extent of the available curated data 64, for example at steps 2913 to 2915. The server 66 first receives such a request from the autonomous vehicle 150 for obtaining data 64 covering the determined area, which is step 3010. At step 3011, the server 66 searches into the database to identify the data 64 covering the determined area. At step 3012, the server 66 sends the data 64 covering the determined area to the autonomous vehicle 150. In some cases, for example at steps 2913 and 2914, the server 66 may not send the data 64 to the autonomous vehicle 150 but rather only send information regarding the data 64, such as a date of the latest scan 28 which was used for obtaining the data 64, or an indication that there is no data 64 available for the determined area. At optional step 3013, if the data 64 is supplied to the user 11 for a fee, a user account is charged for data usage.

In some embodiments, also, steps 2911 and 2912 may be performed by the server 66 rather than by the control system 156 of the autonomous vehicle 150. In such cases, the control system 156 of the autonomous vehicle 150 only sends parameters of the autonomous vehicle 150 such as geographical position, speed and/or direction, and the server 66 manages the other operations of the process by using, for example, the user account comprising a record of the data 64 that is already loaded by the autonomous vehicle 150.

With additional reference to FIG. 31, in some embodiments, the data 64 covering determined areas of territory may be pre-packaged in prevision to a travel instead of being provided one after the other during the travel. In this case, the control system 156 of the autonomous vehicle may send to the server 66 information regarding the autonomous vehicle 150 such as geographical position, speed and/or direction, and also sends information regarding an intended destination of the travel, such as a geographical position. Optionally, the control system 156 can also send to the server 66 information about a route to be followed between the current location and the intended destination. On that basis, the server 66 can determine by overlaying the route on a map which are the areas that need to be covered by the data 64 in order to provide complete coverage for the entire travel. At step 3110, the server 66 receives the route and/or the information regarding the autonomous vehicle 150 and the intended destination. At optional step 3111 if the route is not provided by the control system 156, the route is computed by the server 66. At step 3112, the server 66 searches into the database to determine areas of territory requiring to be covered by the data 64 in order to provide complete coverage for the entire travel. At step 3113, the data 64 is sent to the control system 156 by any suitable means. As such, the autonomous vehicle 150 can proceed to the entire travel without requiring further transaction and/or communications with the server 66; in other words, there is no need for the control system 156 to periodically make requests for new data. At optional step 3114, if the curated data 64 is supplied to the user 11 for a fee, a user account is charged for data usage.

Communication between the autonomous vehicle 150 and the server 66 may be provided by any suitable way. For example, in some cases, communication is made using internet via a wired connection or a wireless connection using Wi-Fi, 3G, 4G, 5G, LTE, or the like.

While in this example the service provided concerns autonomous vehicles, and more particularly autonomous cars and trucks, the scan 28, the virtual scene 37, the methods disclosed herein and the software 62 may be used for any other purpose with a similar approach, such as, for example: for semi-autonomous cars and trucks, for autonomous or semi-autonomous aerial vehicles, for autonomous or semi-autonomous ships; for autonomous or semi-autonomous submarines, for autonomous or semi-autonomous trains, for autonomous or semi-autonomous spaceships, for unmanned vehicles including aerial vehicles (also known as drones), terrestrial and/or naval vehicles, etc.

6) Aerial Navigation

Delivery by unmanned vehicles, such as unmanned aerial vehicles (UAV) (sometimes referred-to as drones) is a growing trend. This delivery method works well for groceries, prepared food orders, pharmacy purchases or any other local deliveries, which need to be made relatively quickly.

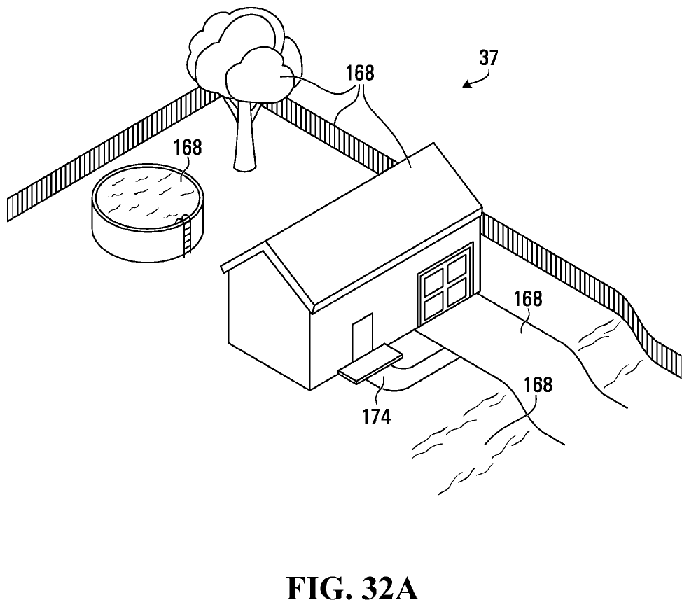

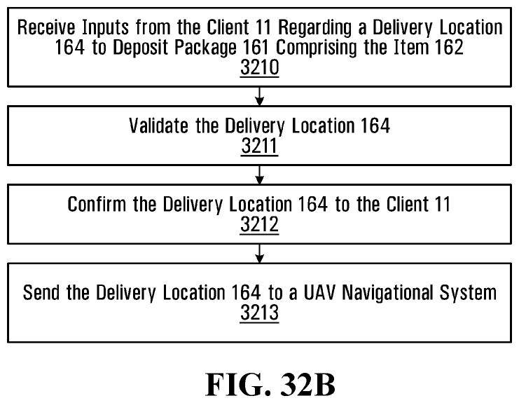

In some embodiments, the software 62 may be used to facilitate navigation, travel and delivery of UAVs 160. For example, with additional reference to FIG. 32, the software 62 may provide means for the user 11, who in this case is a client, to order an item 162 online and provide the client 11 with a possibility to designate a precise delivery location 164 at the delivery premises where the UAV 160 is to drop off the item 162. At the same time, the software 62 may also provide means for the UAV 160 to safely and successfully navigate to the delivery location 64.

In some embodiments, the process may start with the client 11 accessing an online e-commerce website of a merchant and ordering the desired item 162. Once the item 162 has been ordered, arrangements for a delivery of the item 162 may be made using the application 80. The user interface 82 with which the client 11 interacts provides a view of the virtual scene 37, using the data 64 derived from the scan 28 of the delivery location 164 selected by the client 11. Optionally, the user interface 82 may comprise tools allowing the client 11 to designate the delivery location 164; for example, image manipulation tools may be provided to the client 11, allowing the client 11 to use a pointing device and click at, to zoom in, to zoom out or to scroll the view of the virtual scene 37 to identify the delivery location 164 where the UAV 160 is to deposit a package 161 comprising the item 162. For example, the delivery location 164 may be at a residence or at an office of the client 11. More particularly, the delivery location 164 may be a front yard, a backyard or any other suitable location where the client 11 would like to have the package 161 delivered. To avoid errors, the client 11 may be requested to confirm inputs, including the selection of the delivery location 164 to ensure that these are correct. The inputs of the client 11 may be sent to a server 66 which will process the information and prepare an execution of the delivery of the item 162.

Optionally, the user interface 82 may allow the client 11 to designate a secondary delivery location 1642 where the UAV may deposit the package 161 containing the item 162 if, for some reason, the initial delivery location 1641 turns out to be unsuitable while the delivery takes place.

At step 3210, the server 66 may receive inputs from the client 11 regarding the item 162 that is to be delivered and the delivery location 164 to deposit the package 161 comprising the item 162. These inputs are considered by the server 66 because they impact the delivery: for example, if the item 162 is too large and/or too heavy and/or is stored too far away from the delivery location 164, it may be impossible to deliver it using the UAV 160 or delivery may require an additional step. In some cases, also, the dimensions, weight and storing location of the item 162 may have an impact on the model and/or type of the UAV 160 that is being used for the delivery: if the item 162 is heavier, the UAV 160 that is used for the delivery may have a greater payload; if the storing location of the item 162 is further from the delivery location 164, the UAV 160 that is used may have greater radii of action and/or greater endurance; and so on.

Some locations may not be suitable for delivery by UAV because, for example, they may be unsafe to land or they may be inaccessible. For instance, pools, lakes, rivers, flowerbeds, cedar hedges, slopes, inclined roofs, driveways, roadways, and the like, may be unsafe to land; locations under a tree, a roof, a structure or an obstacle, locations cornered or surrounded by vegetation, walls, structures and/or obstacles, and the like, may be inaccessible. Such inaccessible locations may be marked by the software 62 as being no-fly zones 168. Other no-fly zones 168 may comprise locations where flying or landing the UAV 160 may be dangerous, for example in busy areas, near pedestrians, near roadways, on playgrounds, on construction sites, etc. Other no-fly zones 168 are more simply areas where UAVs are forbidden. Also, in some cases, the no-fly zones 168 are surfaces on the land, while in other cases the no-fly zones may be volumetric. At step 3211, the server 66 may validate the delivery location 164 to avoid designated areas that may present a safety hazard for the drone or are unsuitable for other reasons. In this case, this is achieved by computing the no-fly-zones 168 and assessing whether the delivery location 164 is within or surrounded by the no-fly zones 168. If the designated location 164 is not within or surrounded by the no-fly zones 168, the designated location 164 is validated. Otherwise, an error message shown on the user interface 82 may appear to ask the client 11 to pick a different designated location 164.

In some cases, also, identification of the no-fly zones 168 may be performed before the client 11 points to the designated location 164. In this case, the view of the virtual scene 37 to identify the delivery location 164 may show the no-fly zones 168, hence the areas where the UAV 160 cannot fly, and the client 11 may be refrained to select the designated location 164 in these areas. As such, in some cases, the validation at step 3211 may not be required.

At optional step 3212, the server 66 may confirm to the client 11 that the delivery location 164 is validated and that the UAV 160 will deposit the package 161 containing the item 162 at the location 164.

At step 3213, the designated location 164 is communicated to a navigational system of the UAV 160. The UAV 160 may then proceed to the delivery.

The UAV 160 may be equipped with sensors and a control system 170 similar to the sensors 153, 154, 155 and to the control system 156 of the autonomous vehicle 150. The servers 66, 66 of the autonomous vehicle 150 and the UAV 160 may also work similarly and accomplish the same tasks. More generally, the UAV 160 may behave in a fashion that is similar to the autonomous vehicle 150 described earlier.

In some embodiments, also, the control system 170 of the UAV 160 may comprise an AI 172 for real-time object recognition having a working principle similar to the AI layer 63 discussed earlier may be configured to recognize the no-fly zones 168 while it is travelling, using the AI 172. In effect, the AI 172 of the UAV 160 may characterize certain objects of an immediate environment of the UAV 160, such as slopes, pools, inclined roofs, etc., as being no-fly zones 168. In some cases, the AI 172 may surround other objects, such as persons, vehicles, trees, telephone poles, etc., by no-fly zones 168. This capability of the UAV 160 may in some cases replace the step 3211, while in some cases it complements the step 3211.

Alternatively, the UAV 160 may transmit the outputs of the sensors to a server 166 while it is travelling, and the server 166 may use the AI 172 for real-time object recognition. The AI 172 may characterize objects and/or the surrounding of objects of the immediate environment of the UAV 160 as being no-fly zones 168, as previously discussed, and transmit the processed data back to the UAV 160.

In some embodiments, also, the AI 172 of the control system 170 of the UAV 160 may be trained to recognize standard delivery locations 174. The standard delivery location 174 may be a porch of a front door, a porch of a back door, and the like. The standard delivery locations 174 may replace the delivery locations 164 if, for example, the AI 172 of the control system 170 considers the delivery location 164 to be a no-fly zone 168 during delivery, or if the delivery location 164 becomes unsuitable for delivery for any reason. In some cases, the standard delivery location 174 may simply replace the delivery location 164: step 3210 may be skipped and step 3211 to 3213 may be accomplished using the standard delivery location 174 in place of the delivery location 164.

Although in embodiments considered above, the scanning module 20 comprises the camera 22, the Lidar 24 and the GPS receiver 26, the scanning module 20 may comprise any other measurement instruments which may either replace or complement any of the sensors 22, 24, 26. For example, in some embodiments, the scanning module 20 may comprise a radar and/or a sonar and/or a line scanner and/or an UV camera and/or an IR camera and/or an inertial navigation unit (INU), Eddy Current sensors (EDT), magnetic flux leakage (MFL) sensors, near field testing (NFT) sensors and so on.

Although in embodiments considered above, the scanning vehicle 10 is a car or a truck, in other embodiments, the scanning vehicle 10 may be any other type of vehicle and may be free of the frame 12, the powertrain 15, the cabin 16 and/or the operator. For example, in some embodiments, the scanning vehicle 10 may be non-autonomous, semi-autonomous or autonomous, and may be an aerial vehicle, a ship, a submarine, a train, a railcar, a spaceship, a pipeline inspection robot, etc.

Certain additional elements that may be needed for operation of some embodiments have not been described or illustrated as they are assumed to be within the purview of those of ordinary skill in the art. Moreover, certain embodiments may be free of, may lack and/or may function without any element that is not specifically disclosed herein.

Any feature of any embodiment discussed herein may be combined with any feature of any other embodiment discussed herein, in some examples of implementation.

In case of any discrepancy, inconsistency, or other difference between terms used herein and terms used in any document incorporated herein by reference, meanings of the terms used herein are to prevail and be used.

Although various embodiments and examples have been presented, this was for purposes of description, but should not be limiting. Various modifications and enhancements will become apparent to those of ordinary skill in the art.

What is claimed is:

1. A scanning system for scanning a three-dimensional area, the scanning system comprising:
A scanning module comprising:
At least one camera configured to acquire an image data set along a predetermined route in the three-dimensional area;
At least one lidar configured to acquire a lidar data set along the predetermined route; and
At least one GPS receiver configured to acquire a GPS data set along the predetermined route;
A processing module in data communication with the scanning module, the processing module comprising non-transitory computer readable medium having stored thereon instructions that, when executed by a processor, cause the processor to:
Receive the image data set, the lidar data set and the GPS data set; and
Correlate the image data set, the lidar data set and the GPS data set to derive an integrated data set;
wherein the integrated data set is a dimensional representation of the scanned three-dimensional area.

2. A method for scanning a three-dimensional area, the method comprising the steps of:
Receiving an image data set acquired by at least one camera along a predetermined route in the three-dimensional area;
Receiving a lidar data set acquired by at least one lidar along the predetermined route;
Receiving a GPS data set acquired by at least one GPS receiver along the predetermined route; and
Correlating the image data set, the lidar data set and the GPS data set to derive an integrated data set;
wherein the integrated data set is a dimensional representation of the scanned three-dimensional area.
